(19) United States
(12) Patent Application Publication
(10) Pub. No.: US 2026/0288364 A1
(43) Pub. Date: Sep. 24, 2026

(54) PROCESSING-IN-MEMORY (PIM) BASED MEMORY SCHEDULING METHODS AND SYSTEMS FOR CONCURRENT TRANSACTIONS

(71) Applicant: QUALCOMM Incorporated, San Diego, CA (US)

(72) Inventors: Rui Cao, San Diego, CA (US); Subbarao Palacharla, San Diego, CA (US); Pan Deng, San Diego, CA (US); Pankaj Deshmukh, San Diego, CA (US); Jungwon Suh, San Diego, CA (US)

(21) Appl. No.: 19/088,423

(22) Filed: Mar. 24, 2025

(51) Int. Cl. G06F 3/06

(52) U.S. Cl. CPC G06F 3/0655; G06F 3/0604; G06F 3/0673

(57) ABSTRACT

Systems, methods, devices, and apparatuses are disclosed for scheduling processing-in-memory (PIM) transactions and non-PIM transactions efficiently and/or concurrently in a processing-in-memory (PIM) architecture. An example method performed by a memory controller of a PIM device includes: initiating execution of a PIM transaction on the set of PIM memory banks; determining whether a latency of the PIM transaction exceeds a quality of service (QOS) limit; determining whether the PIM transaction is buffering if the latency of the PIM transaction does not exceed the QOS limit; suspending the execution of the PIM transaction based on the latency of the PIM transaction exceeding the QOS limit or based on the PIM transaction buffering if the latency of the PIM transaction does not exceed the QOS limit; and initiating execution of a non-PIM transaction on the set of PIM memory banks of the PIM device.

### TECHNICAL FIELD

This disclosure relates generally to processing-in-memory (PIM) architectures, and more specifically, to PIM architectures supporting memory scheduling for concurrent transactions.

### BACKGROUND

Modern computing systems increasingly handle large-scale matrix computations, particularly in artificial intelligence (AI) applications such as Large Language Models (LLMs). These computations often require significant memory bandwidth and computational resources. Such computing systems, such as mobile systems on a chip (SOCs), also typically utilize a single memory shared across various SOC clients, such as but not limited to the central processing unit (CPU), graphic processing unit (GPU), and the neural signal processor (NSP). Processing-in-memory (PIM) architectures have emerged as a solution to address the memory bandwidth bottleneck by performing computations closer to where data resides. In PIM architectures, computational units (also referred to herein as “PIM units”) are integrated within memory devices, such as Dynamic Random Access Memory (DRAM), to enable matrix-vector operations to be performed directly within the memory device. This approach can leverage higher memory bandwidth that is available inside the DRAM device compared to traditional architectures, i.e., where data must be transferred between memory and processor.

Although memory-bound applications, such as LLMs, benefit from PIM processes in the DRAM (such applications referred to herein as “PIM applications”), other applications achieve more optimal performance with a standard memory system. For example, some user facing, real-time applications demand a greater quality of service and may be better suited for the standard memory system. Such applications, referred to herein as non-PIM applications, may still need to share the same DRAM or other memory resources intended for PIM applications, especially in mobile SoC systems. There is thus a desire and need for PIM applications and non-PIM applications to be able to run efficiently and/or concurrently in such mobile SoC systems. In particular, there is a desire and need for an efficient technique to maintain high DRAM bandwidth utilization for PIM applications while also meeting quality of service (QoS) requirements of real-time non-PIM applications.

Various embodiments of the present disclosure address one or more of the aforementioned shortcomings.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes systems, methods, devices, and apparatuses for scheduling processing in memory (PIM) transactions and non-PIM transactions that efficiently utilizes PIM based memory resources while allowing the PIM and non-PIM transactions to run concurrently. As used herein, a transaction may refer to any one or more tasks of an application (e.g., a PIM application or a non-PIM application), and which may include at least one read-type sequence and at least one write-type sequence. Aspects of the subject matter described in this disclosure can be implemented in a processing-in-memory (PIM) device. The PIM device may include a memory (e.g., DRAM) storing a plurality of or a set of memory banks (referred to herein as PIM memory banks). Furthermore, the memory may include one or more registers, such as but not limited to a write vector register, a load multiplication accumulation (MAC) register, and an accumulator register for use as hardware for storing contexts for transactions. A memory controller may operate on the memory and may schedule concurrent PIM and non-PIM transactions in the PIM device.

In at least one embodiment, the memory controller may schedule PIM and non-PIM transactions in the PIM device by devoting a set of PIM memory banks to one of a PIM transaction or a non-PIM transaction and scheduling a switch to the other of the PIM transaction or the non-PIM transaction based on a quality of service (QOS) limit or an efficiency criteria. For example, the memory controller may switch the use of the set of memory banks from servicing a first type of transaction (e.g., PIM transaction) to servicing a second type of transaction (e.g., non-PIM transaction) based on the QOS limit by determining monitoring the latency of the first transaction to determine whether the latency exceeds a predefined QOS limit (e.g., the first transaction takes too long and may thus impact a quality of service for a user). If the latency exceeds the QOS limit, the memory controller may cause the set of PIM memory banks to switch to servicing the second type of transaction (e.g., non-PIM transaction) (e.g., by suspending the execution of the first transaction to be completed at a later stage). Furthermore, the memory controller may switch the use of the set of memory banks from servicing the first type of transaction (e.g., PIM transaction) to servicing the second type of transaction (e.g., non-PIM transaction) based on the efficiency criteria by monitoring and/or determining whether the first transaction is buffering. If so, the memory controller may switch the use of the set of PIM memory banks to service the second transaction (non-PIM transaction) instead until a later event (e.g., until the first transaction has buffered at least above a buffer threshold).

In some embodiments, the memory controller may concurrently schedule PIM and non-PIM transactions in the PIM device based on the write-type and read-type sequences of each transaction. For example, the write-type sequences may include write vectors in PIM transactions and write commands in non-PIM transactions, whereas read-type sequences may include load MAC operations associated with the PIM transactions and read commands in the non-PIM transactions. The memory controller may cause one or more of the set of PIM memory banks to service either the write-type sequences of the transactions or the read-type sequences of the transactions and switch between the write-type sequences and the read-type sequences based on various criteria. The memory controller may initiate execution for either the write-type sequences or the read-type sequences by assigning an active PIM memory bank to the PIM transaction for executing at least one write vector (e.g., the write vectors associated with the PIM transaction in a batch of write-type sequences) or at least one load MAC operation (e.g., the load MAC operations associated with the PIM transaction in a batch of read-type sequences), respectively. The memory controller may then assign remaining PIM memory banks (e.g., non-active PIM memory banks) for the execution of at least one write command of the non-PIM transaction (if the memory controller had initiated execution of a batch of write-type sequences) or at least one read command of the non-PIM transaction (if the memory controller had initiated execution of a batch of read-type sequences), respectively. In some embodiments, the memory controller may cause the switch between the use of the set of PIM memory banks from executing write-type sequences to executing read-type sequences (or vice versa) based on the completion of the at least one write vector of the PIM transaction (e.g., the write vectors associated with the PIM transaction in a batch of write-type sequences) or at least one load MAC operation of the PIM transaction (e.g., the write vectors associated with the PIM transaction in a batch of write-type sequences), respectively. In some embodiments, the memory controller may monitor the latency of a non-PIM transaction (e.g., a duration of time for executing write command(s) or read command(s) of the non-PIM transaction) to determine whether the latency exceeds a QOS limit. If the latency exceeds the QOS limit, the memory controller may assign a more active memory bank for servicing the non-PIM transaction in order to alleviate the latency. For example, the memory controller may swap the memory bank relied on by the PIM transaction and the memory bank relied on by the latent non-PIM transaction.

The memory controller may thus enable effective and efficient scheduling of PIM transactions and non-PIM transactions using the same set of PIM memory banks in a manner that optimizes the unique and often divergent needs of each transaction. For example, by enabling a switch based on a latency of a transaction reaching a QOS limit, the memory controller may enable certain transactions (e.g., non-PIM transactions) to optimize for QOS. Furthermore, by enabling a switch based on determining that a transaction is buffering, the memory controller may enable both transactions to use the PIM memory resources efficiently, by allowing a non-buffering transaction to execute on the set of memory banks until the buffering transaction has buffered to a predetermined buffer threshold.

In one aspect of the disclosure, a method for efficiently scheduling processing-in-memory (PIM) and non-PIM transactions in a PIM device includes: initiating, by a memory controller of the PIM device, execution of a PIM transaction on a set of PIM memory banks of the PIM device; determining, by the memory controller, whether a latency of the PIM transaction exceeds a quality of service (QOS) limit; determining, by the memory controller, whether the PIM transaction is buffering if the latency of the PIM transaction does not exceed the QOS limit; suspending, by the memory controller, the execution of the PIM transaction based on the latency of the PIM transaction exceeding the QOS limit or based on the PIM transaction buffering if the latency of the PIM transaction does not exceed the QOS limit; and initiating, by the memory controller, execution of a non-PIM transaction on the set of PIM memory banks of the PIM device.

In additional aspect of the disclosure, a method for efficiently scheduling processing-in-memory (PIM) and non-PIM transactions in a PIM device includes: executing, by a memory controller, a batch of write type sequences in a set of PIM memory banks, wherein the batch of write type sequences includes at least one write vector associated with a PIM transaction and at least one write command associated with a non-PIM transaction; and executing, by the memory controller, after execution of the at least one write vector associated with the PIM transaction, a batch of read type sequences in the set of PIM memory banks, wherein the batch of read type sequences includes at least one load MAC operation associated with the PIM transaction and at least one read command associated with the non-PIM transaction.

In an additional aspect of the disclosure, an apparatus is disclosed for efficiently scheduling processing in memory (PIM) and non-PIM transactions. The apparatus includes: a memory comprising a set of PIM memory banks; and a memory controller coupled to the memory and configured to perform operations including: initiating execution of a PIM transaction on the set of PIM memory banks; determining whether a latency of the PIM transaction exceeds a quality of service (QOS) limit; determining whether the PIM transaction is buffering if the latency of the PIM transaction does not exceed the QOS limit; suspending the execution of the PIM transaction based on the latency of the PIM transaction exceeding the QOS limit or based on the PIM transaction buffering if the latency of the PIM transaction does not exceed the QOS limit; and initiating execution of a non-PIM transaction on the set of PIM memory banks of the PIM device.

In an additional aspect of the disclosure, an apparatus is disclosed for efficiently scheduling processing in memory (PIM) and non-PIM transactions. The apparatus includes: a memory comprising a set of PIM memory banks; and a memory controller coupled to the memory and configured to perform operations including: executing a batch of write type sequences in a set of PIM memory banks, wherein the batch of write type sequences includes at least one write vector associated with a PIM transaction and at least one write command associated with a non-PIM transaction; and executing, after execution of the at least one write vector associated with the PIM transaction, a batch of read type sequences in the set of PIM memory banks, wherein the batch of read type sequences includes at least one load MAC operation associated with the PIM transaction and at least one read command associated with the non-PIM transaction.

In an additional aspect of the disclosure, a non-transitory computer-readable medium stores instructions that, when executed by a processor, cause the processor to perform operations. The operations include: initiating, by a memory controller of the PIM device, execution of a PIM transaction on a set of PIM memory banks of the PIM device; determining, by the memory controller, whether a latency of the PIM transaction exceeds a quality of service (QOS) limit; determining, by the memory controller, whether the PIM transaction is buffering if the latency of the PIM transaction does not exceed the QOS limit; suspending, by the memory controller, the execution of the PIM transaction based on the latency of the PIM transaction exceeding the QOS limit or based on the PIM transaction buffering if the latency of the PIM transaction does not exceed the QOS limit; and initiating, by the memory controller, execution of a non-PIM transaction on the set of PIM memory banks of the PIM device.

These and other implementations may each optionally include one or more of the following features. For instance, various implementations may include one or more of: parallel processing capabilities, different memory configurations, various block sizes, different bit-width combinations, and different scaling factor arrangements.

The various aspects, implementations, and features disclosed herein may be implemented in a variety of ways. For example, aspects may be implemented as a device, such as a processing-in-memory device, a memory controller, or an integrated circuit. Aspects may also be implemented as one or more methods or processes. Further, aspects may be implemented as instructions stored in a computer-readable storage medium that, when executed by one or more processors, cause the processors to perform the disclosed operations. Such computer-readable storage media may include, but are not limited to, random access memory (RAM), read-only memory (ROM), electrically erasable programmable read-only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium capable of storing instructions for execution by processors.

The various aspects may also be implemented in hardware, software, firmware, or any combination thereof. For instance, aspects may be implemented as dedicated circuits or logic configured to execute the described functionality. Alternatively or additionally, aspects may be implemented as programs, modules, routines, or other software components executed by one or more processors. In some implementations, aspects may be implemented using application-specific integrated circuits (ASICs), field-programmable gate arrays (FPGAs), or other programmable logic devices.

The details of one or more implementations are set forth in the accompanying drawings and description below. Other features and advantages will be apparent from the description and drawings, and from the claims. It is to be understood that both the foregoing general description and the following detailed description are exemplary and explanatory only and are not restrictive of the invention, as claimed. Features shown in the various figures can be combined and/or modified in ways not explicitly shown, while remaining within the scope of the claims.

### DESCRIPTION OF THE FIGURES

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a processing-in-memory system that can be configured for scheduling processing-in-memory (PIM) transactions and non-PIM transactions in a PIM DRAM architecture efficiently and/or concurrently according to one or more aspects of this disclosure.

FIG. 2A shows a block diagram illustrating a basic PIM DRAM architecture that can support matrix-vector multiplication and block quantization according to one or more aspects of this disclosure.

FIG. 2B shows an operational flow diagram illustrating matrix-vector multiplication processes within the PIM DRAM architecture according to one or more aspects of this disclosure.

FIG. 3 shows an operational flow diagram of an example method for efficiently scheduling processing-in-memory (PIM) and non-PIM transactions according to one or more aspects of this disclosure.

FIGS. 4A-4B show flow charts of example methods performed by a memory controller for efficiently scheduling processing-in-memory (PIM) and non-PIM transactions according to one or more aspects of this disclosure.

FIG. 5 shows an operational flow diagram of an example method for scheduling PIM and non-PIM transactions concurrently based on read-type and write-type sequences according to one or more aspects of this disclosure.

FIG. 6 shows a flow chart of an example method performed by a memory controller for scheduling PIM and non-PIM transactions concurrently based on read-type and write-type sequences according to one or more aspects of this disclosure.

FIG. 7 shows a block diagram of an example PIM device configured to support and efficient and concurrent scheduling of PIM and non-PIM transactions according to one or more aspects of this disclosure.

Like reference numbers and designations in the various drawings indicate like elements.

### DETAILED DESCRIPTION

The present disclosure provides systems, apparatus, methods, and computer-readable media that support improved processing-in-memory (PIM) operations, such as techniques for scheduling processing in memory (PIM) transactions and non-PIM transactions efficiently and concurrently.

Shortcomings of previous techniques mentioned here are only representative and are included to highlight problems that the inventors have identified with respect to existing processing-in-memory devices and sought to improve upon. As previously discussed, PIM applications and non-PIM applications often have different focuses and/or needs. PIM applications, such as LLMs benefit from relying on PIM processes in a PIM memory bank (e.g., DRAM), as that may provide much needed efficiency. PIM applications can be negatively impacted, however, if non-PIM applications utilizing PIM memory resources begin to buffer or otherwise result in an inefficient allocation of PIM memory resources. On the other hand, non-PIM applications, such as real-time user-facing applications, typically demand a greater quality of service (QOS). When non-PIM applications share the same PIM memory resources as PIM applications, non-PIM applications can thus be negatively impacted by latencies resulting from the non-PIM or PIM applications as the latency may negatively impact the QOS of the non-PIM applications.

There is thus a desire and need for PIM applications and non-PIM applications to be able to run concurrently in such mobile SoC systems. In particular, there is a desire and need for an efficient technique to maintain high DRAM bandwidth utilization for PIM applications while also meeting quality of service (QoS) requirements of real-time non-PIM applications. Aspects of devices described below may address some or all of these shortcomings as well as others known in the art. Aspects of the improved devices described herein may present other benefits than, and be used in other applications than, those described above.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, memory devices, and processes to provide a thorough understanding of the present disclosure. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a processing-in-memory device.

Aspects of the disclosure involve techniques for scheduling PIM and non-PIM transactions efficiently and concurrently in a PIM architecture. As used herein, a transaction may refer to any one or more tasks of an application (e.g., a PIM application or a non-PIM application), and which may include at least one read-type sequence and at least one write-type sequence. The PIM architecture may involve a PIM device that includes a memory and a memory controller operating on the memory. The memory (e.g., a DRAM, an SRAM, etc.) may include a plurality of or a set of memory banks (referred to herein as PIM memory banks). Each memory bank may include one or more registers (e.g., a vector register, an accumulator register, a multiplication accumulation (MAC) unit, etc.) for processing sequences of a transaction. A memory controller may operate on the memory and may schedule concurrent PIM and non-PIM transactions in the PIM device.

The memory controller may schedule PIM and non-PIM transactions by assigning a set of PIM memory banks to execute one of a PIM transaction or a non-PIM transaction and scheduling a switch to the other of the PIM transaction or the non-PIM transaction based on a quality of service (QOS) limit or an efficiency criterion. For example, the memory controller may switch the use of the set of memory banks from servicing a first type of transaction (e.g., PIM transaction) to servicing a second type of transaction (e.g., non-PIM transaction) based on the QOS limit by monitoring the latency of the first transaction to determine whether the latency of the first transaction exceeds a predefined QOS limit. For example, the first transaction taking too long may impact a quality of service for a user as it may delay the delivery of another transaction (e.g., second transaction) that the user may be awaiting for. Thus, in some embodiments, the QOS limit may be specific to transactions that may be potentially delayed (second transaction) as a result of the servicing of another transaction (first transaction). If the latency exceeds the QOS limit (e.g., of the second transaction), the memory controller may cause the set of PIM memory banks to switch to servicing the second transaction (e.g., non-PIM transaction), for example, by suspending the execution of the first transaction for the first transaction to be completed at a later stage. Furthermore, the memory controller may switch the use of the set of memory banks from servicing the first transaction (e.g., PIM transaction) to servicing the second transaction (e.g., non-PIM transaction) based on the efficiency criteria by monitoring and/or determining whether the first transaction is buffering. A transaction may be buffering if it may not be utilizing the PIM memory bank to its full capacity. For example, the transaction may be found to be buffering if the transaction is at an end of a page hit stream (e.g., when there may no longer be open page registers causing the transaction to wait for a page register to open up), if a page hit ratio of the transaction satisfies a predetermined threshold, and/or if a command queue occupancy rate of the transaction satisfies a predetermined threshold. If the first transaction is buffering, the memory controller may switch the use of the set of PIM memory banks to service the second transaction (non-PIM transaction) instead. After the set of memory banks executes the second transaction, the memory controller may cause the set of memory banks to switch back to executing the first transaction based on one or both of the aforementioned switching criteria (e.g., the latency of the second transaction exceeding a QOS limit (e.g., of the first transaction) and/or the second transaction buffering and thus impacting an efficiency in the allocation of the PIM memory bank resources). In some embodiments, the memory controller may cause PIM memory banks to switch back to executing the first transaction after the first transaction has buffered at least above a predetermined buffer threshold.

Also or alternatively, the memory controller may concurrently schedule PIM and non-PIM transactions in the set of PIM memory banks based on the write-type and read-type sequences of each transaction. For example, the write-type sequences may include write vectors in PIM transactions and write commands in non-PIM transactions, whereas read-type sequences may include load MAC operations in PIM transactions and read commands in non-PIM transactions. The memory controller may cause the set of PIM memory banks to service either write-type sequences of the transactions or the read-type sequences of the transactions and switch between the write-type sequences and the read-type sequences based on various criteria. The memory controller may initiate execution for either the write-type sequences or the read-type sequences by assigning an active PIM memory bank to the PIM transaction for executing at least one write vector or at least one load MAC operation, respectively. The memory controller may then assign remaining PIM memory banks (e.g., non-active PIM memory banks) for the execution of at least one write command or at least one read command, respectively, of the non-PIM transactions. In some embodiments, the memory controller may cause the switch between the use of the set of PIM memory banks from executing write-type sequences to executing read-type sequences (or vice versa) based on the completion of the at least one write vector or at least one load MAC operation of the PIM transaction, respectively. In some embodiments, the memory controller may monitor the latency of a non-PIM transaction (e.g., write command or a read command of non-PIM transaction) to determine whether the latency exceeds a QOS limit. If the latency exceeds the QOS limit, the memory controller may assign a more active memory bank for servicing the non-PIM transaction in order to alleviate the latency. For example, the memory controller may swap the memory bank relied on by the PIM transaction and the memory bank relied on by the latent non-PIM transaction.

Particular implementations of the subject matter described in this disclosure may be implemented to realize one or more of the following potential advantages or benefits. In some aspects, the memory controller may thus enable effective and efficient scheduling of PIM transactions and non-PIM transactions using the same set of PIM memory banks in a manner that optimizes the unique and often divergent needs of each transaction. For example, by enabling a switch based on a latency of a transaction reaching a QOS limit, the memory controller may enable certain transactions (e.g., non-PIM transactions) to optimize for QOS. Furthermore, by enabling a switch based on determining that a transaction is buffering, the memory controller may enable both transactions to use the PIM memory resources efficiently, by allowing a non-buffering transaction to execute on the set of memory banks until the buffering transaction has buffered to a predetermined buffer threshold. The foregoing features combine to create a highly efficient processing environment within the PIM device.

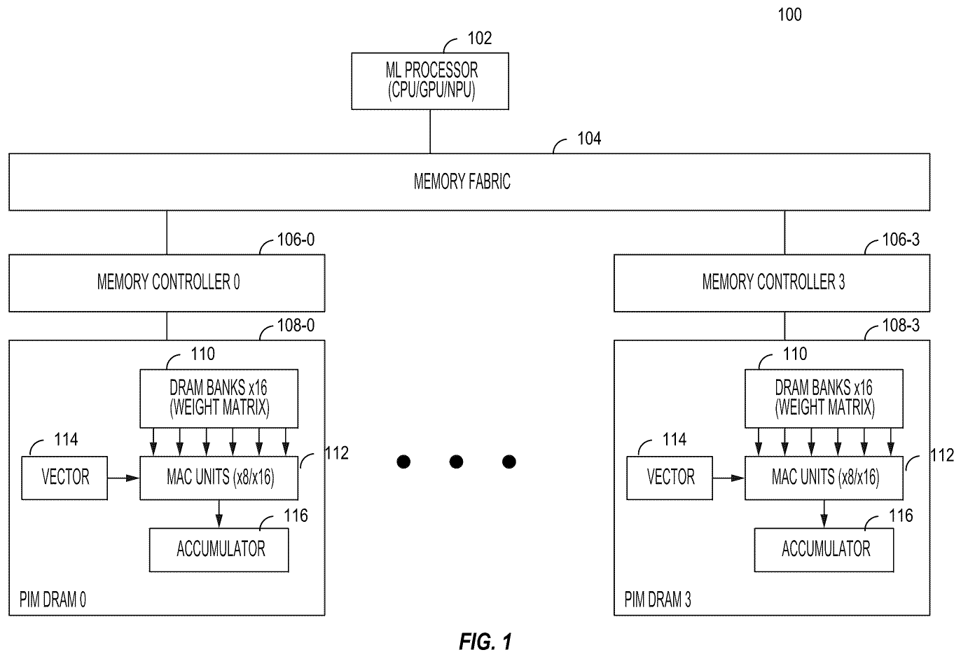

FIG. 1 is a block diagram of a processing-in-memory system that can be configured for scheduling PIM and non-PIM transactions efficiently and concurrently according to aspects described herein. System 100 include one or more processors or processor cores 102 associated with one or more SoC clients. The one or more processors 102 may be used in machine learning (ML), AI, and/or other computationally intensive applications, and may be implemented using various processing architectures. For example, the one or more processors 102 may include but bare not limited to a central processing unit (CPU), graphics processing unit (GPU), neural processing unit (NPU), application-specific integrated circuit (ASIC), or combinations thereof. The one or more processor 102 can be configured to manage high-level operations, distribute computational tasks (e.g., further among other processors and/or SoC clients), and coordinate processing across memory devices.

A memory fabric 104 couples to the one or more processors 102 and enables data movement and processing capabilities. Memory fabric 104 can be specialized to support various processing-in-memory operations through command handling, routing protocols, and synchronization mechanisms. The fabric 104 may implement different interconnect technologies and topologies depending on system requirements, including point-to-point connections, crossbar switches, or mesh networks.

Memory fabric 104 connects to one or more multiple memory controllers 106 (illustrated as memory controllers 106-0 through 106-3 in one implementation, though other quantities may be implemented). Each memory controller 106 can be configured to support processing-in-memory commands and operations beyond traditional memory access patterns. Furthermore each memory controller 106 may perform operations on the memory 108 and may interface with the one or more processors 102 corresponding to one or more SoC clients (e.g., compute subsystems). Memory controllers 106 may implement specialized command queues, reordering logic, and timing control to manage both conventional memory operations and processing-in-memory functions. Furthermore, each memory controller 106 may implement write-type and read-type operations using the memory 108, for PIM transactions and non-PIM transactions of applications performed by the one or more processors 102. Different implementations may employ varying numbers of controllers based on factors such as system size, bandwidth requirements, and power constraints.

Each memory controller 106 couples to a corresponding memory 108 in the PIM device. As shown in FIG. 1, an example of such memory 108 may be a processing-in-memory DRAM (PIM DRAM) device, and the PIM DRAM is being shown and referenced for ease of explanation. However, though other memory devices for PIM are also contemplated (e.g., PIM SRAM) and can be substituted for PIM DRAM where applicable. While four PIM DRAM devices (108-0 through 108-3) for the memory are shown, systems may scale from single devices to large arrays of devices. Each PIM DRAM 108 includes multiple DRAM banks 110 (also referred to herein as “memory banks” or “PIM memory banks”), which may be implemented in various configurations (for example, eight, sixteen, or thirty-two banks per device). The DRAM banks 110 can be configured to store different types of data, such as but not limited to weight matrices for neural network computations, activation values, or general computational data structures. DRAM Banks 110 may be organized into different zones or regions optimized for specific access patterns or computational requirements.

Within each PIM DRAM 108, multiply-accumulate (MAC) units 112 couple to DRAM banks 110 and can be configured to perform various computational operations, e.g., from basic multiplication and accumulation to more complex functions. The number and capability of MAC units 112 may vary by implementation, with configurations ranging from four to thirty-two units being common examples. MAC units 112 can support multiple precision formats (for example, 4-bit, 8-bit, 16-bit operations) and various operational modes, including Single Instruction Multiple Data (SIMD) execution where a single command triggers parallel execution across all units within a device.

Vector interfaces 114 (also referred to herein as “vectors,” “or “vector registers” or “write vector registers”) provide input paths for write vector data into MAC units 112. These interfaces can support different data widths and formats, enabling flexible handling of input vectors. Vector accumulators 116 (also referred to herein as “accumulators” or accumulator registers”) couple to MAC units 112 in each PIM DRAM 108 and can be configured with varying bit widths and accumulation depths based on application requirements.

The system supports sophisticated execution models across different hierarchical levels. Within each PIM DRAM 108, SIMD execution enables efficient parallel processing across MAC units. Across different PIM DRAM devices 108, Multiple Instruction Multiple Data (MIMD) execution allows independent operations to proceed in parallel, which are managed through software orchestration via spawn and synchronization mechanisms controlled by ML processor 102.

Memory controllers 106 implement complex coordination mechanisms to manage both traditional memory access as well as processing-in-memory operations. This can include specialized command scheduling, resource allocation, and synchronization across multiple devices. The architecture enables significant bandwidth improvements compared to traditional approaches by minimizing data movement between memory and processing units. In operation, system 100 can handle heterogeneous and/or diverse computational workloads by distributing operations among one or more SoC clients (via their respective processors and/or processor cores 102), and, in some embodiments, among multiple PIM DRAM devices 108. Furthermore, the system 100 can support both PIM transactions and non-PIM transactions by having the memory controller 106 facilitate and schedule the PIM and non-PIM transactions in a manner efficiently and/or concurrently using the set of PIM memory banks 110 of the PIM DRAM devices 108. Data structures may be partitioned and distributed across DRAM banks 110 in various ways depending on application requirements. The architecture supports different scaling approaches, from small embedded systems to large computational arrays, while maintaining the benefit of performing computations close to data storage.

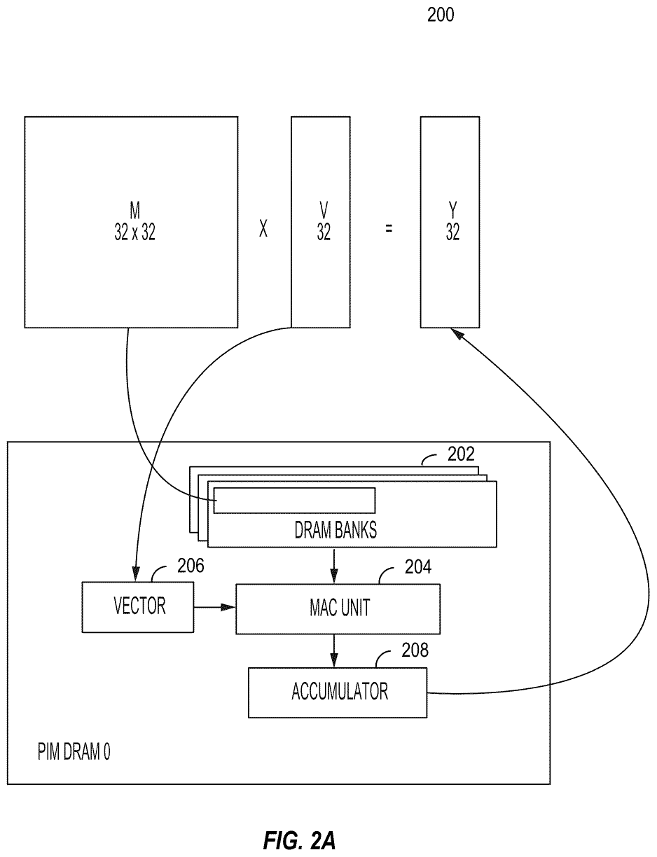

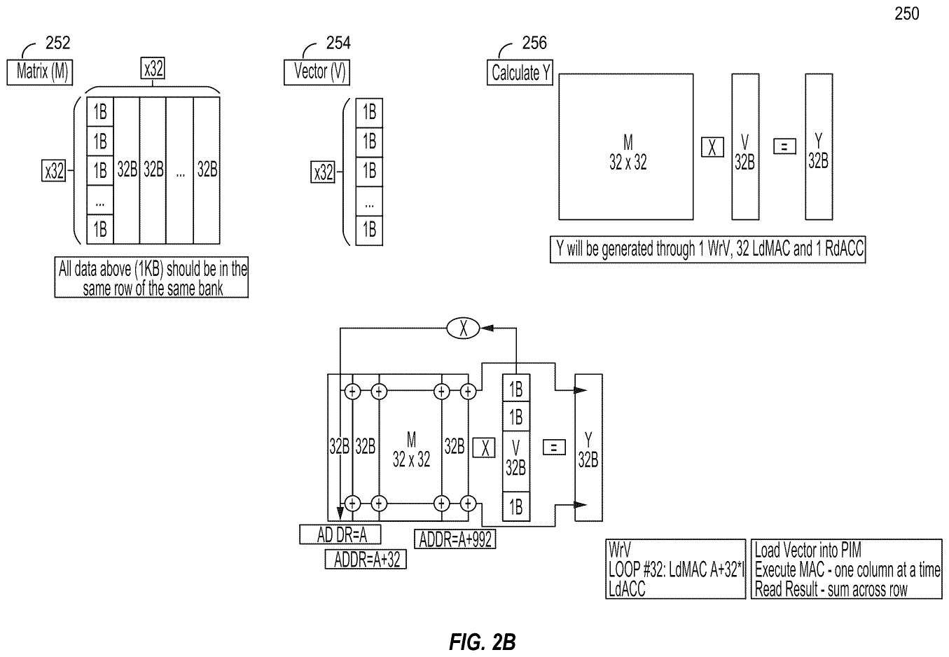

FIGS. 2A and 2B illustrate processing-in-memory operation fundamentals that can support efficient matrix computations, including the scheduling of PIM transactions and non-PIM transactions efficiently and concurrently, according to aspects described herein. FIG. 2A shows a basic PIM DRAM architecture 200 while FIG. 2B illustrates the corresponding operational flow 250 of matrix-vector multiplication within the architecture.

Referring to FIG. 2A, a PIM DRAM architecture 200 can include one or more DRAM banks 202 (memory banks), each configurable to store matrix data, such as neural network weight matrices. In mobile or resource-constrained systems, these weights may be stored in reduced precision formats, such as 4-bit values, to minimize memory footprint. A MAC unit 204 can couple to a DRAM bank 202 and may process matrix values along with vector inputs. Vector register 206 can provide storage for input vectors (e.g., write vectors) and may couple to MAC unit 204 (e.g., to perform load MAC operations). An accumulator 208 can couple to MAC unit 204 and may store operation results.

FIG. 2B details the operational flow 250 of matrix-vector multiplication within architecture 200. A weight matrix M 252 can be arranged as a 32×32 matrix occupying, for example, 1 kilobyte of memory in DRAM bank 202, though other sizes and arrangements may be implemented. An input vector V 254 may comprise 32 elements stored in vector register 206, with the size being configurable based on implementation requirements. The multiplication operation produces a result vector Y 256 that can be stored in accumulator 208.

The operational sequence can begin with a Write Vector (WrV) operation that loads input data into vector register 206. After activating the appropriate DRAM page, the system can perform a series of Load and MAC (also referred to herein as “Load MAC” or “LdMAC”) operations, processing one matrix column at a time through MAC unit 204. Results may accumulate in accumulator 208 and can be accessed through Load Accumulator (LdACC) operations.

Implementation of the PIM architecture 200, as shown in FIGS. 2A and 2B, can support the efficient and/or concurrent scheduling of PIM transactions and non-PIM transactions in a manner that utilizes the PIM memory banks 202 efficiently while optimizing for QOS. For example, a set of PIM memory banks 202 be used to execute one of a PIM transaction or a non-PIM transaction. A memory controller may cause the set of PIM memory banks 202 to switch to executing the other of the PIM transaction or the non-PIM transaction based on QOS-based or efficiency-based criteria described herein. The execution of a PIM transaction may involve using the vector register 206 to input one or more write vectors associated with the PIM transaction and using the MAC unit 204 to conduct one or more load MAC operations associated with the PIM transaction. The execution of the non-PIM transaction may involve using the vector register 206 to input one or more write commands associated with the non-PIM transaction and using the MAC unit 204 to conduct one or more read commands associated with the non-PIM transaction.

Also or alternatively, the memory controller may determine a batch of write-type sequences based on the write vectors associated with the PIM transaction and write commands associated with the non-PIM transaction, and may determine a batch of read-type sequences based on the load MAC operations associated with the PIM transaction and read commands associated with the non-PIM transaction. The memory controller may cause the set of PIM memory banks 202 to execute one of the batches of write-type sequences or the read-type sequences. The memory controller may subsequently cause the set of PIM memory banks 202 to switch to executing the other of the batch of write-type sequences or read-type sequences. The PIM architecture 200 may support execution of write-type sequences by inputting write vectors associated with a PIM transaction, or write commands associated with the non-PIM transaction into the vector register 206. For example, in some embodiments, the memory controller may determine a write vector corresponding to a write command of a non-PIM transaction for input into the vector register 206. The PIM architecture 200 may support execution of read-type sequences by conducting load MAC operations vectors associated with a PIM transaction using the MAC unit 204, or read commands associated with the non-PIM transaction using the MAC unit 204. For example, in some embodiments, the memory controller may determine a load MAC operation corresponding to a read command of a non-PIM transaction for use with the MAC unit 204. In some embodiments, the set of DRAM banks 202 may include an active PIM memory bank typically used (e.g., by default) for PIM transactions. The remaining PIM memory banks may include one or more non-active PIM memory banks that may be used for the execution of the non-PIM transactions.

These and other implementations can build upon the architecture and operational flow illustrated in FIGS. 2A and 2B, with various implementations possible depending on system requirements and constraints.

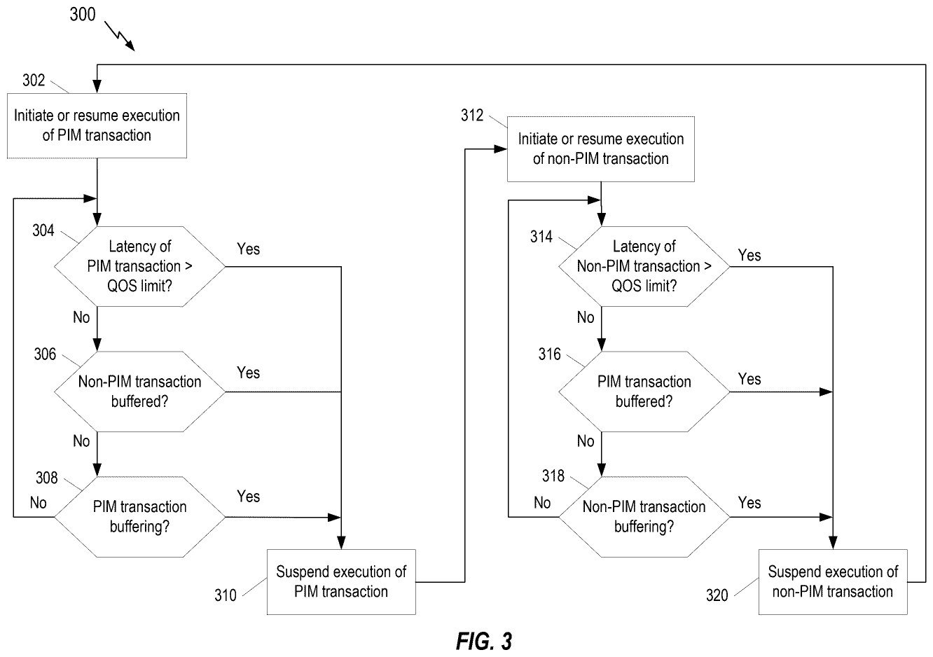

FIG. 3 shows a flow chart of an example method 300 performed by a memory controller for efficiently scheduling processing-in-memory (PIM) and non-PIM transactions according to one or more aspects of this disclosure. For example, process 300 may be performed by the memory controller 106 of memory 108 of the PIM device. In some embodiments, the memory controller may be configured to perform one or more of the following blocks based on executable instructions stored in the memory (e.g., memory 108).

Process 300 may begin with the memory controller (e.g., memory controller 106) initiating or resuming execution of a PIM transaction (block 302). The execution may occur on a set of PIM memory banks (e.g., DRAM banks 110 and 202). In some embodiments, the memory controller may initiate the execution of the PIM transaction by enabling or unblocking a precharge function and an activation function on a PIM memory bank on the PIM device. Also or alternatively, if a PIM transaction was previously executed on the PIM device but then suspended, block 302 may include resuming execution of the PIM transaction. The execution of the PIM transaction may involve inputting write vectors associated with the PIM transaction into vector registers of the PIM device (e.g., vector registers 114 and 206 of devices 100 and 200, respectively) and performing load MAC operations associated with the PIM transaction using the MAC units of the PIM device (e.g., MAC units 112 and 204 of devices 100 and 200, respectively). The memory controller may determine whether to switch from executing the PIM transaction to executing the non-PIM transaction based on several criteria, as described in blocks 304 through 308. It is also contemplated that, in some embodiments, process 300 may alternately begin with the memory controller initiating execution of a non-PIM transaction at block 312. In such embodiments, the memory controller may determine whether to switch from executing the non-PIM transaction to executing the PIM transaction based on several criteria, as described in blocks 314 through 318. For ease of explanation, process 300 will be described based on initially executing the PIM transaction at block 302.

At block 304, the memory controller (e.g., memory controller 106) may determine whether a latency of the PIM transaction exceeds a QOS limit (e.g., of another transaction (e.g., non-PIM transaction)). For example, the memory controller may monitor the time spent by the PIM transaction (e.g., periodically, semi-periodically, or continuously) to determine whether the duration of time (e.g., the latency) exceeds a QOS limit (e.g., a predefined time limit) of another transaction (e.g., non-PIM transaction) that is being delayed as a result of the memory banks being used to service the current transaction (e.g., PIM transaction). A duration exceeding the QOS limit (e.g., the predefined time limit) may be deemed or understood to negatively impact a QOS for a user intended to use an application that relies at least on the non-PIM transaction.

In some embodiments, for example, where a non-PIM transaction was previously executed and then suspended due to the non-PIM transaction buffering, the memory controller (e.g., memory controller 106) may determine whether the non-PIM transaction has buffered (block 306). A reason for this determination at block 306 may be in order to determine when the non-PIM transaction can resume execution from its current suspension of execution, as the PIM transaction may have been executing for the duration at which the non-PIM transaction was buffering and in suspension. The end of the buffering of the non-PIM transaction may thus signal that the execution of the non-PIM transaction can be resumed (and therefore no longer be in a suspension state). However, resuming the non-PIM transaction may involve suspending the PIM transaction in order to transfer use of memory banks from use by the PIM transaction to use by the non-PIM transaction.

Thus, at block 308, the memory controller (e.g., memory controller 106) may determine whether the PIM transaction is buffering. It is contemplated that a transaction that is determined to be buffering may not be utilizing the PIM memory bank to its full capacity. For example, another transaction (e.g., non-PIM transaction) may use the PIM memory bank for execution while the PIM transaction is buffering. Thus, the assessment at block 308, and subsequent switching to a non-PIM transaction if the PIM transaction is found to be buffering allows for an efficient usage of the PIM memory resources. In some embodiments, determining whether a transaction (e.g., the PIM transaction) is buffering includes the memory controller determining whether the transaction is at an end of a page hit stream. For example, the PIM memory bank (e.g., DRAM bank 110 and 202) may include a plurality of page registers, which may be open (e.g., accessible for service, active, etc.), idle (e.g., inactive), or closed (e.g., unavailable). A page hit may be defined as an operation of a transaction that involves a successful access to an open page register. At an end of a page hit stream, there may no longer be open page registers, which may cause the transaction (e.g., the PIM transaction) to wait for a page register to open up. Also or alternatively, the memory controller may determine whether the transaction is buffering by determining whether a page hit ratio of the transaction satisfies a predetermined threshold. For example, the page hit ratio may be based on a ratio of the number of times the memory controller successfully accesses an open page register to the total number of times a page register is accessed (e.g., regardless of whether the page register was open, idle, or closed). Also or alternatively, the memory controller may determine whether the transaction is buffering by determining whether a command queue occupancy rate of the transaction satisfies a predetermined threshold.

If the memory controller determines that any one or more of the aforementioned criteria are met (e.g., the latency of the PIM transaction exceeds the QOS limit, the non-PIM transaction has buffered, and/or the PIM transaction is determined to be buffering), the memory controller (e.g., memory controller 106) may suspend the execution of the PIM transaction at block 310. For example, suspending the PIM transaction may involve blocking the precharge and activation functions in the PIM memory banks used by the PIM transaction to suspend the PIM transaction, and then unblocking the precharge and activation functions to allow the non-PIM transaction to execute on the PIM memory banks. Furthermore, in embodiments where the memory controller prompts the switch to the non-PIM transaction after determining that the latency of the PIM transaction exceeds the QOS limit, the memory controller may need not perform the further assessments described in blocks 306 and 308, as the failure of the latency of the PIM transaction to be within the QOS limit may be sufficient of a reason to switch transactions.

In some embodiments, one or more of the assessments at blocks 304-308 may be performed in parallel. Alternatively, the assessments at blocks 304-308 may be performed sequential. In some embodiments, process 300 may advance to block 310 based on or after a positive determination at any of, or one or more of, the assessments at blocks 304-308.

In some embodiments, suspending the PIM transaction to switch to a non-PIM transaction may involve blocking the activation and precharge functions and blocking or suspending a write vector operation. After a predetermined number of load MAC vectors has been serviced (e.g., after the blocking or suspension of the write vector operation), the load MAC operation may also be blocked, in order to suspend the PIM transaction to switch to the non-PIM transaction. Blocking the load MAC operation after the predetermined number of load MAC vectors are serviced may be effective for suspending the PIM transaction as PIM transactions may typically spawn long load MAC operations for a given DRAM. For real-time applications, blocking load MAC operations may be particularly effective to ensure QOS.

After suspending the execution of the PIM transaction, the memory controller (e.g., memory controller 106) may initiate or resume execution of a non-PIM transaction on the set of PIM memory banks at block 312. The execution may occur on at least one of or all of the set of PIM memory banks (e.g., DRAM banks 110 and 202) previously used for the execution of the PIM transaction. In some embodiments, the memory controller may initiate the execution of the non-PIM transaction by enabling or unblocking a precharge function and an activation function on a PIM memory bank on the PIM device. The precharge and activation functions for the PIM memory bank may have been previously blocked to suspend the execution of the PIM transaction on the PIM memory bank. Also or alternatively, if a non-PIM transaction was previously executed on the PIM device but then suspended, block 302 may involve resuming execution of the non-PIM transaction.

The execution of the non-PIM transaction may involve implementing write commands and read commands associated with the non-PIM transaction. In at least one embodiment, implementing the write commands may involve determining one or more corresponding write vectors to input into vector registers of the PIM device (e.g., vector registers 114 and 206 of devices 100 and 200, respectively). Furthermore, in at least one embodiment, implementing the read commands may involve determining one or more corresponding load MAC operations to be performed using the MAC units of the PIM device (e.g., MAC units 112 and 204 of devices 100 and 200, respectively).

The memory controller may determine whether to switch from executing the non-PIM transaction to resuming (e.g., switching back to) the PIM transaction or initiating execution of a different PIM transaction based on several criteria, as described in blocks 314 through 318.

At block 314, the memory controller (e.g., memory controller 106) may determine whether a latency of the non-PIM transaction exceeds a QOS limit. For example, the memory controller may monitor the time spent executing the non-PIM transaction (e.g., periodically, semi-periodically, or continuously) to determine whether the duration of time (e.g., the latency) exceeds a QOS limit (e.g., a predefined time limit). In some embodiments, the QOS limit for which the duration of time executing the non-PIM transaction is compared to (in block 314) may be a different time limit from the QOS limit for which the duration of time executing the PIM transaction is compared to (in block 304). In at least one embodiment, QOS limits (e.g., in blocks 304 or 314) may be set, may be configured, and/or otherwise may be specific to application needs and/or user preferences. A duration exceeding the QOS limit (e.g., the predefined time limit) may be deemed or understood to negatively impact a QOS for a user intended to use an application that may rely on any transactions delayed as a result of servicing the non-PIM transaction in block 314.

If the previously suspended PIM transaction was suspended responsive to the memory controller determining that the PIM transaction was buffering, the memory controller (e.g., memory controller 106) may determine whether the PIM transaction has buffered (block 316). In some embodiments, the memory controller may determine that the PIM transaction has buffered if the PIM transaction has buffered above a buffer threshold. For example, the PIM transaction may have achieved a page hit ratio above a predetermined threshold, or may have achieve a command queue ratio above a predetermined threshold.

At block 318, the memory controller (e.g., memory controller 106) may determine whether the non-PIM transaction is buffering. As previously discussed, the memory controller can determine whether the non-PIM transaction is buffering based on determining that the non-PIM transaction is at an end of a page hit stream, determining that a page hit ratio of the non-PIM transaction satisfies a predetermined threshold, and/or by determining that a command queue occupancy rate of the non-PIM transaction satisfies a predetermined threshold.

If the memory controller determines that any of the aforementioned criteria is met (e.g., the latency of the non-PIM transaction exceeds the QOS limit, the PIM transaction has buffered, or the non-PIM transaction is determined to be buffering), the memory controller (e.g., memory controller 106) may suspend the execution of the non-PIM transaction at block 320. For example, suspending the non-PIM transaction may involve blocking the precharge and activation functions in the PIM memory banks used by the non-PIM transaction to suspend the non-PIM transaction, and then unblocking the precharge and activation functions to allow the PIM transaction to resume execution on the PIM memory banks (or to allow execution of a new or different PIM transaction). Furthermore, in embodiments where the memory controller prompts the switch to the PIM transaction after determining that the latency of the non-PIM transaction exceeds the QOS limit, the memory controller may need not perform the further assessments described in blocks 316 and 318, as the failure of the latency of the non-PIM transaction to be within the QOS limit may be sufficient of a reason to switch transactions.

After suspending the execution of the non-PIM transaction, the memory controller may initiate or resume execution of a PIM transaction on the set of PIM memory banks and repeat one or more of the aforementioned blocks.

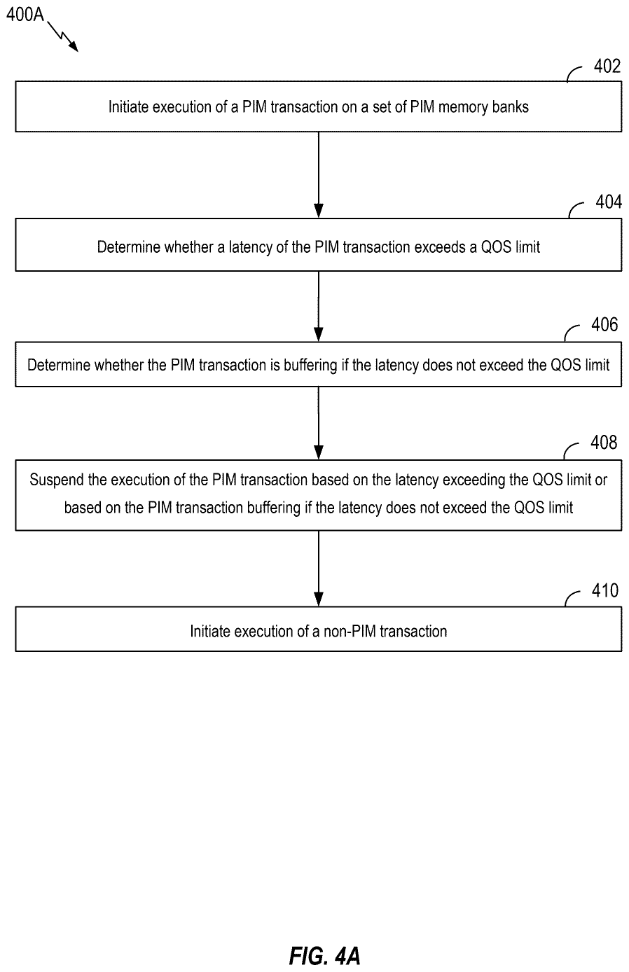

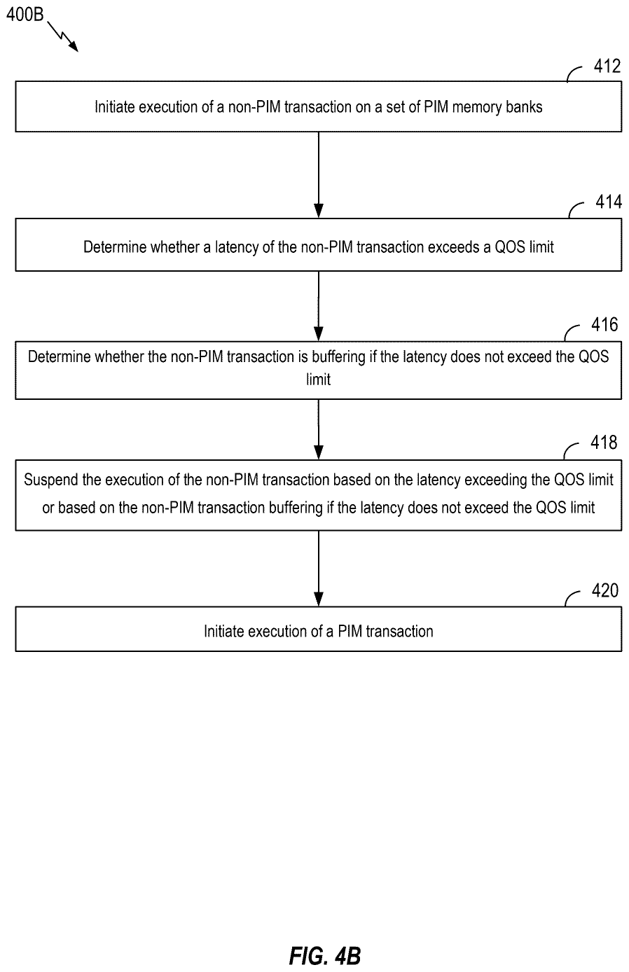

FIG. 4A shows a flow chart of an example method 400A performable by or at a memory controller of a PIM device for efficiently scheduling processing-in-memory (PIM) and non-PIM transactions according to one or more aspects of this disclosure. The memory controller of the PIM device can implement process 400A through various hardware and software components working together to support scheduling PIM and non-PIM transactions efficiently and/or concurrently, and in a manner that optimizes QOS while maintaining efficient use of PIM memory resources. For example, process 400A may be performed by the memory controller 106 of memory 108 of the PIM device. In some embodiments, the memory controller may be configured to perform one or more of the following blocks based on executable instructions stored in the memory (e.g., memory 108).

At block 402, the memory controller (e.g., memory controller 106) may initiate execution of a PIM transaction on a set of PIM memory banks. For example, the memory controller may assign one or more PIM memory banks 202 (e.g., DRAM banks 110) to be used for the PIM transaction. The execution may involve inputting at least one write vector associated with the PIM transaction into a PIM memory bank via the vector register 114 and performing one or more load MAC operations using one or more MAC units 112. In some embodiments, initiating the execution may involve enabling or otherwise unblocking an activation function (e.g., ACT) and a precharge function (e.g., PRE) for a given PIM memory bank used for the execution of a task or sequence in a PIM transaction.

At block 404, the memory controller (e.g., memory controller 106) may determine whether a latency of the PIM transaction exceeds a QOS limit. In some embodiments, the memory controller may determine whether a latency of the PIM transaction exceeds a QOS limit by continuously, periodically, or semi-periodically monitoring a duration expended by the execution of the PIM transaction to see whether it exceeds with a predefined time limit. A duration exceeding the QOS limit (e.g., the predefined time limit) may be deemed or understood to negatively impact a QOS for a user intended to use an application relying on any transactions affected by the delay of the PIM transaction. In some embodiments, the memory controller may determine that a latency of the PIM transaction exceeds the QOS limit. In such embodiments, the memory controller may suspend the execution of the PIM transaction based on the latency of the PIM transaction exceeding the QOS limit, and may initiate or resume a non-PIM transaction on at least one memory bank of the set of memory banks. For example, suspending the PIM transaction may involve blocking the precharge and activation functions in the PIM memory banks used by the PIM transaction and then unblocking the precharge and activation functions to allow the non-PIM transaction to execute on the PIM memory banks. Furthermore, in embodiments where the memory controller prompts the switch to the non-PIM transaction after determining that the latency of the PIM transaction exceeds the QOS limit, subsequent block 406 may not be performed.

At block 406, the memory controller (e.g., memory controller 106) may determine whether the PIM transaction is buffering if the latency does not exceed the QOS limit. For example, while exceeding the QOS limit may prompt the memory controller to cause the set of PIM memory banks to switch from servicing the PIM transaction to servicing the non-PIM transaction, a second criteria for prompting the memory controller to cause the switch may be based on efficiency of the use of the PIM memory banks. If a PIM transaction is determined to be buffering, the PIM memory bank on which the PIM transaction is performed is not being utilized to its full capacity. For example, another transaction (e.g., non-PIM transaction) may use the PIM memory bank for execution while the PIM transaction is buffering. Thus, block 406 allows for an efficient usage of the PIM memory resources.

In some embodiments, determining whether a transaction (e.g., PIM transaction or non-PIM transaction) is buffering includes the memory controller determining whether the transaction is at an end of a page hit stream. For example, the PIM memory bank (e.g., DRAM bank) may include a plurality of page registers, which may be open (e.g., accessible for service, active, etc.), idle (e.g., inactive), or closed (e.g., unavailable). A page hit may be defined as an operation of a transaction that involves a successful access to an open page register. At an end of a page hit stream, there may no longer be open page registers, which may cause the transaction (e.g., PIM transaction or non-PIM transaction) to wait for a page register to open up. Also or alternatively, the memory controller may determine whether the transaction is buffering by determining whether a page hit ratio of the transaction satisfies a predetermined threshold. For example, the page hit ratio may be based on a ratio of the number of times the memory controller successfully accesses an open page register to the total number of times a page register is accessed (e.g., regardless of whether the page register was open, idle, or closed). Also or alternatively, the memory controller may determine whether the transaction is buffering by determining whether a command queue occupancy rate of the transaction satisfies a predetermined threshold.

At block 408, the memory controller (e.g., memory controller 106) may suspend the execution of the PIM transaction. The execution of the PIM transaction may be suspended based on the latency of the PIM transaction exceeding the QOS limit. Alternatively, the execution of the PIM transaction may be suspended based on the memory controller determining that the PIM transaction buffering if the latency does not exceed the QOS limit. In some embodiments, suspending the execution of the PIM transaction includes blocking an activation function and a precharge function for the PIM transaction on the set of PIM memory banks of the PIM device.

At block 410, the memory controller (e.g., memory controller 106) may initiate the execution of a non-PIM transaction. The non-PIM transaction may be initiated on at least one of the sets of PIM memory banks. The at least one PIM memory bank may have been previously used for the PIM transaction. In some embodiments, for example, where a non-PIM transaction was previously executed and then suspended, prior to initiating execution of the PIM transaction in block 402, the memory controller may resume the execution of the non-PIM transaction at block 410. In some embodiments, initiating or resuming the non-PIM transaction may include unblocking an activation function and a precharge function for the non-PIM transaction on the at least one PIM memory bank of the set of PIM memory banks of the PIM device.

In some embodiments, suspending the PIM transaction (e.g., at block 408) to switch to a non-PIM transaction (e.g., at block 410) may involve blocking the activation and precharge functions and blocking or suspending a write vector operation. After a predetermined number of load MAC vectors has been serviced for the PIM transaction (e.g., after the blocking or suspension of the write vector operation of the PIM transaction), the load MAC operation may also be blocked, in order to suspend the PIM transaction to switch to the non-PIM transaction. Blocking the load MAC operation after the predetermined number of load MAC vectors are serviced may be effective for suspending the PIM transaction as PIM transactions may typically spawn long load MAC operations for a given DRAM. For real-time applications, blocking load MAC operations may be particularly effective to ensure QOS.

In some embodiments, if the memory controller initiated or resumed execution of the non-PIM transaction based on the PIM transaction buffering, the memory controller may cause the at least one or set of the PIM memory banks to switch back to (e.g., resume) execution of the PIM transaction after the PIM transaction has buffered. For example, the memory controller may determine that the PIM transaction has buffered above a buffer threshold (e.g., if a latency of the non-PIM transaction otherwise does not exceed the QOS limit). The memory controller may then suspend the execution of the non-PIM transaction based on the PIM transaction having buffered above the buffer threshold, and may resume execution of the PIM transaction.

Also or alternatively (e.g., as shown in FIG. 4B), one or more of the aforementioned blocks may be repeated for the non-PIM transaction for the memory controller to prompt a switch to the PIM transaction. For example, the memory controller may determine that a latency of the non-PIM transaction exceeds the QOS limit. The memory controller may then suspend the execution of the non-PIM transaction based on the latency of the non-PIM transaction exceeding the QOS limit, and resume execution of the PIM transaction. As previously discussed, the memory controller may suspend the execution of a transaction (e.g., a PIM transaction or a non-PIM transaction) by blocking an activation function and a precharge function for the respective transaction, and may resume or initiate the execution of a transaction (e.g., non-PIM transaction or a PIM transaction) on a PIM memory bank by unblocking the activation function and the precharge function for the respective transaction on the PIM memory bank.

FIG. 4B shows a flow chart of another example method 400B performable by or at a memory controller of a PIM device for efficiently scheduling processing-in-memory (PIM) and non-PIM transactions according to one or more aspects of this disclosure. The memory controller of the PIM device can implement process 400B through various hardware and software components working together to support scheduling PIM and non-PIM transactions efficiently and/or concurrently, and in a manner that optimizes QOS while maintaining efficient use of PIM memory resources. For example, process 400B may be performed by the memory controller 106 of memory 108 of the PIM device. In some embodiments, process 400B may be performed by the memory controller subsequent to, responsive to, or otherwise based on one or more blocks of process 400A. In some embodiments, the memory controller may be configured to perform one or more of the following blocks based on executable instructions stored in the memory (e.g., memory 108).

At block 412, the memory controller (e.g., memory controller 106) may initiate execution of a non-PIM transaction on a set of PIM memory banks. For example, the memory controller may assign one or more PIM memory banks 202 (e.g., DRAM banks 110) to be used for the non-PIM transaction. The execution may involve inputting at least one write vector associated with the non-PIM transaction into a PIM memory bank via the vector register 114 and performing one or more load MAC operations using one or more MAC units 112. In some embodiments, initiating the execution may involve enabling or otherwise unblocking an activation function (e.g., ACT) and a precharge function (e.g., PRE) for a given PIM memory bank used for the execution of a task or sequence in a non-PIM transaction.

At block 414, the memory controller (e.g., memory controller 106) may determine whether a latency of the non-PIM transaction exceeds a QOS limit. In some embodiments, the memory controller may determine whether a latency of the non-PIM transaction exceeds a QOS limit by continuously, periodically, or semi-periodically monitoring a duration expended by the execution of the non-PIM transaction to see whether it exceeds with a predefined time limit. A duration exceeding the QOS limit (e.g., the predefined time limit) may be deemed or understood to negatively impact a QOS for a user intended to use an application relying on any transactions affected by the delay of the non-PIM transaction. In some embodiments, the QOS limit for which the duration of time executing the non-PIM transaction is compared to (in block 414) may be a different time limit from the QOS limit for which the duration of time executing the PIM transaction is compared to (in block 404). In at least one embodiment, QOS limits (e.g., in blocks 404 or 414) may be set, may be configured, and/or otherwise may be specific to application needs and/or user preferences. In some embodiments, the memory controller may determine that a latency of the non-PIM transaction exceeds the QOS limit. In such embodiments, the memory controller may suspend the execution of the non-PIM transaction based on the latency of the non-PIM transaction exceeding the QOS limit, and may initiate or resume a PIM transaction on at least one memory bank of the set of memory banks. For example, suspending the non-PIM transaction may involve blocking the precharge and activation functions in the PIM memory banks used by the non-PIM transaction and then unblocking the precharge and activation functions to allow the PIM transaction to execute on the PIM memory banks. Furthermore, in embodiments where the memory controller prompts the switch to the PIM transaction after determining that the latency of the non-PIM transaction exceeds the QOS limit, subsequent block 416 may not be performed.

At block 416, the memory controller (e.g., memory controller 106) may determine whether the non-PIM transaction is buffering if the latency does not exceed the QOS limit. For example, while exceeding the QOS limit may prompt the memory controller to cause the set of PIM memory banks to switch from servicing the non-PIM transaction to servicing the PIM transaction, a second criteria for prompting the memory controller to cause the switch may be based on efficiency of the use of the PIM memory banks. If the non-PIM transaction is determined to be buffering, the PIM memory bank on which the non-PIM transaction is performed may not be utilized to its full capacity. For example, another transaction (e.g., PIM transaction) may use the PIM memory bank for execution while the non-PIM transaction is buffering. Thus, block 416 allows for an efficient usage of the PIM memory resources.

In some embodiments, determining whether a transaction (e.g., PIM transaction or non-PIM transaction) is buffering includes the memory controller determining whether the transaction is at an end of a page hit stream. For example, the PIM memory bank (e.g., DRAM bank) may include a plurality of page registers, which may be open (e.g., accessible for service, active, etc.), idle (e.g., inactive), or closed (e.g., unavailable). A page hit may be defined as an operation of a transaction that involves a successful access to an open page register. At an end of a page hit stream, there may no longer be open page registers, which may cause the transaction (e.g., PIM transaction or non-PIM transaction) to wait for a page register to open up. Also or alternatively, the memory controller may determine whether the transaction is buffering by determining whether a page hit ratio of the transaction satisfies a predetermined threshold. For example, the page hit ratio may be based on a ratio of the number of times the memory controller successfully accesses an open page register to the total number of times a page register is accessed (e.g., regardless of whether the page register was open, idle, or closed). Also or alternatively, the memory controller may determine whether the transaction is buffering by determining whether a command queue occupancy rate of the transaction satisfies a predetermined threshold.

At block 418, the memory controller (e.g., memory controller 106) may suspend the execution of the non-PIM transaction. The execution of the non-PIM transaction may be suspended based on the latency of the non-PIM transaction exceeding the QOS limit. Alternatively, the execution of the non-PIM transaction may be suspended based on the memory controller determining that the non-PIM transaction is buffering if the latency does not exceed the QOS limit. In some embodiments, suspending the execution of the non-PIM transaction includes blocking an activation function and a precharge function for the non-PIM transaction on the set of PIM memory banks of the PIM device.

At block 420, the memory controller (e.g., memory controller 106) may initiate the execution of a PIM transaction. The PIM transaction may be initiated on at least one of the sets of PIM memory banks. The at least one PIM memory bank may have been previously used for the non-PIM transaction. In some embodiments, for example, where a PIM transaction was previously executed and then suspended, prior to initiating execution of the non-PIM transaction in block 412, the memory controller may resume the execution of the PIM transaction at block 420. In some embodiments, initiating or resuming the PIM transaction may include unblocking an activation function and a precharge function for the PIM transaction on the at least one PIM memory bank of the set of PIM memory banks of the PIM device.

In some embodiments, suspending the non-PIM transaction (e.g., at block 418) to switch to a PIM transaction (e.g., at block 420) may involve blocking the activation and precharge functions and blocking or suspending a write vector operation. After a predetermined number of load MAC vectors has been serviced for the non-PIM transaction (e.g., after the blocking or suspension of the write vector operation of the non-PIM transaction), the load MAC operation may also be blocked, in order to suspend the non-PIM transaction to switch to the PIM transaction.

In some embodiments, if the memory controller initiated or resumed execution of the PIM transaction based on the non-PIM transaction buffering, the memory controller may cause the at least one or set of the PIM memory banks to switch back to (e.g., resume) execution of the non-PIM transaction after the non-PIM transaction has buffered. For example, the memory controller may determine that the non-PIM transaction has buffered above a buffer threshold (e.g., if a latency of the PIM transaction otherwise does not exceed the QOS limit). The memory controller may then suspend the execution of the PIM transaction based on the non-PIM transaction having buffered above the buffer threshold, and may resume execution of the non-PIM transaction.

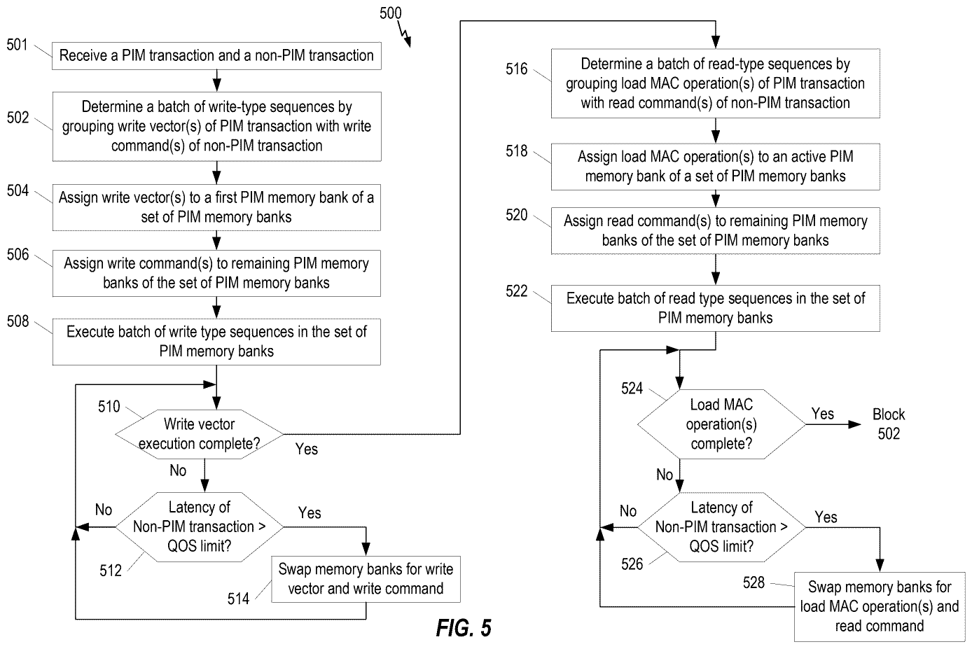

FIG. 5 shows an operational flow diagram of an example method (e.g., process 500) for scheduling PIM and non-PIM transactions concurrently based on read-type and write-type sequences according to one or more aspects of this disclosure. For example, process 500 may be performed by the memory controller 106 of memory 108 of the PIM device. In some embodiments, the memory controller may be configured to perform one or more of the following blocks based on executable instructions stored in the memory (e.g., memory 108).

Process 500 may begin with the memory controller (e.g., memory controller 106) receiving a PIM transaction and a non-PIM transaction for concurrent scheduling at block 501. For example, receiving the PIM transaction and the non-PIM transaction may be a part of a request or command to concurrently schedule the executions of these transactions in the PIM device according to techniques described herein.

At block 502, the memory controller (e.g., memory controller 106) may determine a batch of write-type sequences by grouping write vector(s) of PIM transaction with write command(s) of non-PIM transaction. For example, in some embodiments, the grouping may involve arranging an order for executing the sequences (e.g., write vector(s) and write command(s)) and/or an order of priority with which each sequence is assigned to PIM memory banks. In some embodiments, the write vector(s) associated with the PIM transaction may be given priority or otherwise may be at the start of a batch.

At block 504, the memory controller (e.g., memory controller 106) may assign write vector(s) to a first PIM memory bank of a set of PIM memory banks. For example, the first PIM memory bank may be an open or active memory bank that is usable and available for the PIM transaction, and which may be assigned for the PIM transaction. In some embodiments, a PIM memory bank may be active or may be rendered active based on the execution of or unblocking of the precharge and activation functions, but may be rendered inactive or idle based on the blocking of the precharge and activation functions.

At block 506, the memory controller (e.g., memory controller 106) may assign write command(s) to remaining PIM memory banks of the set of PIM memory banks. In some embodiments, in contrast to the first PIM memory bank, which may be active, the remaining PIM memory banks may be idle or otherwise inactive. For example, the said remaining PIM memory banks may need to be activated by unblocking or enabling a precharge function and an activation function to allow such memory banks to be repurposed or reused for the execution of the write commands of the non-PIM transaction.

At block 508, the memory controller (e.g., memory controller 106) may execute the batch of write type sequences in the set of PIM memory banks. For example, the memory controller may execute the write vector(s) (e.g., of the PIM transaction) in the batch by inputting the write vector(s) into the vector register 206 of a PIM memory bank 206. In some embodiments, the memory controller may execute the write command(s) (e.g., of the non-PIM transaction) of the batch by determining corresponding write vector(s) to input into the vector register 206.

The memory controller may determine whether to switch from executing the batch of write-type sequences (of both the PIM and non-PIM transactions) to executing a batch of read-type sequences (of both the PIM and non-PIM transactions) based on various criteria.

For example, at block 510, the memory controller (e.g., memory controller 106) may determine whether execution of the write vector(s) associated with the PIM transaction is complete. It is contemplated that an order of sequences in a PIM transaction may be critical, such that a PIM transaction may need to have its write vector(s) executed before a subsequent read-type sequence can be executed. Thus, if the memory controller determines that the write vector(s) of the batch have been executed, the memory controller may switch to executing the read-type sequences.

At block 512, the memory controller (e.g., memory controller 106) may determine whether a latency of the non-PIM transaction exceeds a QOS limit. For example, the memory controller may determine whether the latency of the non-PIM transaction exceeds the QOS limit by monitoring the latency (e.g., duration of time expended by the execution of the non-PIM transaction) to see whether it exceeds the QOS limit (e.g., a predefined time limit). A duration exceeding the QOS limit (e.g., the predefined time limit) may be deemed or understood to negatively impact a QOS for a user intended to use an application relying on transactions affected by (e.g., any transactions delayed as a result of) the memory banks servicing the non-PIM transaction. Also or alternatively, the QOS limit may be based on factors independent of transactions affected by the memory banks servicing the non-PIM transaction. In some embodiments, the memory controller may determine whether the latency of the non-PIM transaction exceeds the QOS limit (block 512) after the memory controller has completed execution of the write vector(s) associated with the PIM transaction at block 510.

If the latency of the non-PIM transaction exceeds the QOS limit, the memory controller may swap the PIM memory banks used by the PIM transaction with the PIM memory bank used by the latent non-PIM transaction (block 514). For example, the memory controller may suspend the execution of the at least one write vector (of the PIM transaction) on the first PIM memory bank, and then execute at least a part of the non-PIM transaction on the first PIM memory bank (e.g., by unblocking an activation function and a precharge function for the non-PIM transaction on the first PIM memory bank). The at least one write vector of the PIM transaction may be resumed on at least one of the remaining PIM memory banks (e.g., by unblocking an activation function and a precharge function for the PIM transaction on the at least one of the remaining PIM memory banks). The at least one of the remaining PIM memory banks on which the PIM transaction is resumed may be the PIM memory bank previously used by the latent non-PIM transaction. By swapping and/or reassigning memory banks, the QOS of the non-PIM transaction can be optimized by having a more active memory bank service the non-PIM transaction in order to reduce or overcome the latency. Thereafter one or more blocks 510 through 514 may be repeated.

If at least the write vector associated with the PIM transaction is completed, the memory controller may switch to executing the batch of read-type sequences (of both PIM and non-PIM transactions). In some embodiments, prior to executing the batch of read-type sequences, the memory controller may determine a batch of read-type sequences by grouping load MAC operation(s) of the PIM transaction with read command(s) of the non-PIM transaction (block 516).

At block 518, the memory controller (e.g., memory controller 106) may assign load MAC operation(s) to an active PIM memory bank of a set of PIM memory banks. In some embodiments, the active PIM memory bank may be the first PIM memory bank on which the write vector(s) of the earlier batch of write-type sequences was executed. In another embodiment, the active PIM memory bank may not be the first PIM memory bank. As previously discussed, a PIM memory bank may be active or may be rendered active based on the execution of or unblocking of the precharge and activation functions, but may be rendered inactive or idle based on the blocking of the precharge and activation functions.

At block 520, the memory controller (e.g., memory controller 106) may assign read command(s) to remaining PIM memory banks of the set of PIM memory banks. In some embodiments, in contrast to the active PIM memory bank on which the load MAC operation(s) are assigned, the remaining PIM memory banks may be idle or otherwise inactive. For example, the said remaining PIM memory banks may need to be activated by unblocking or enabling a precharge function and an activation function to allow such memory banks to be repurposed or reused for the execution of the read commands of the non-PIM transaction.

At block 522, the memory controller (e.g., memory controller 106) may execute the batch of read type sequences in the set of PIM memory banks. For example, executing load MAC operation(s) (e.g., of the PIM transaction) of the batch may include using the MAC unit 204 of the PIM memory bank 110 to perform the load MAC operation(s). In some embodiments, executing read command(s) (e.g., of the non-PIM transaction) of the batch may include determining a corresponding load MAC operation to perform using the MAC unit 204 of the PIM memory bank 110.

The memory controller (e.g., memory controller 106) may determine whether to switch from executing the batch of read-type sequences (of both the PIM and non-PIM transactions) to executing a next and/or a new batch of write-type sequences (of both the PIM and non-PIM transactions) based on various criteria.

For example, at block 524, the memory controller (e.g., memory controller 106) may determine whether execution of the load MAC operation(s) associated with the PIM transaction is complete. It is contemplated that since the order of sequences in a PIM transaction may be critical, a PIM transaction may need to have its load MAC operation(s) completed before a subsequent batch of write-type sequences can be executed. Thus, if the memory controller determines that the load MAC operation(s) of the batch has been completed, the memory controller may switch to executing a new and/or a different batch of write-type sequences, for example, by iterating one or more of blocks 502 through 524.

Also or alternatively, at block 526, the memory controller (e.g., memory controller 106) may determine whether a latency of the non-PIM transaction (e.g., execution of the read commands of the non-PIM transaction) exceeds a QOS limit. For example, the memory controller may determine whether the latency of the non-PIM transaction exceeds the QOS limit by monitoring the latency (e.g., duration of time expended by the execution of the read commands of the non-PIM transaction) to see whether it exceeds the QOS limit (e.g., a predefined time limit). A duration exceeding the QOS limit (e.g., the predefined time limit) may be deemed or understood to negatively impact a QOS for a user intended to use an application that relies on transactions affected by (e.g., any transactions delayed as a result of) the PIM memory banks servicing the non-PIM transaction. Also or alternatively, the QOS limit may be based on factors independent of transactions affected by the memory banks servicing the non-PIM transaction. In some embodiments, the memory controller may determine whether the latency of the non-PIM transaction exceeds the QOS limit (block 526) after the memory controller has completed execution of the load MAC operation(s) associated with the PIM transaction at block 524.

If the latency of the non-PIM transaction exceeds the QOS limit, the memory controller (e.g., memory controller 106) may swap the PIM memory banks used by the PIM transaction with the PIM memory bank used by the latent non-PIM transaction at block 528 (e.g., such as in the manner described in block 514). For example, the memory controller may suspend the execution of the load MAC operation(s) (of the PIM transaction) on the assigned active PIM memory bank (e.g., by blocking the activation and precharge functions), and then execute at least a part of the non-PIM transaction on that PIM memory bank (e.g., by unblocking the activation and precharge functions for the non-PIM transaction on that PIM memory bank). The load MAC operation(s) of the PIM transaction may be resumed on at least one of the remaining PIM memory banks (e.g., by unblocking an activation function and a precharge function for the PIM transaction on the at least one of the remaining PIM memory banks). The at least one of the remaining PIM memory banks on which the PIM transaction is resumed may be the PIM memory bank previously used by the latent non-PIM transaction. By swapping and/or reassigning memory banks, the QOS of the non-PIM transaction can be optimized by having a more active memory bank service the non-PIM transaction in order to reduce or overcome the latency. Thereafter one or more blocks 524 through 528 may be repeated.

In some embodiments, after a PIM transaction (e.g., the load MAC and write vector operations of the PIM transaction) is completed on a PIM memory bank, the next PIM transaction (e.g., a next batch of load MAC and write vector operations) may be performed on another PIM memory bank (e.g., a subsequent PIM memory bank in a series of PIM memory banks). The PIM memory bank previously used for the first PIM transaction may be rendered usable for the non-PIM transactions. Thus, the allotment of PIM memory banks to non-PIM transactions (e.g., after use by PIM transactions) may further improve efficiency in completing transactions (e.g., improving QOS) and optimize the efficient use of PIM hardware resources.

In some embodiments, suspending a PIM transaction to switch to a non-PIM transaction, such as when a swapping the use of a memory bank from a PIM transaction to a non-PIM transaction, may involve blocking the activation and precharge functions and blocking or suspending a write vector operation for the PIM transaction. After a predetermined number of load MAC vectors has been serviced (e.g., after the blocking or suspension of the write vector operation), the load MAC operation may also be blocked, in order to suspend the PIM transaction to switch to the non-PIM transaction.

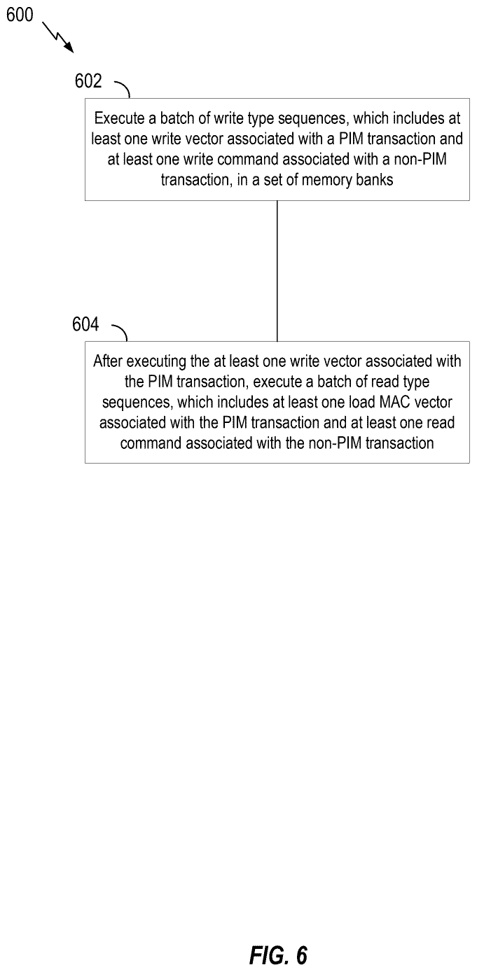

FIG. 6 shows a flow chart of an example method performable at or by a memory controller for scheduling PIM and non-PIM transactions concurrently based on read-type and write-type sequences according to one or more aspects of this disclosure. The memory controller of the PIM device can implement process 600 through various hardware and software components working together to support scheduling PIM and non-PIM transactions efficiently and/or concurrently, and in a manner that optimizes QOS while maintaining efficient use of PIM memory resources. For example, process 600 may be performed by the memory controller 106 of memory 108 of the PIM device. In some embodiments, the memory controller may be configured to perform one or more of the following blocks based on executable instructions stored in the memory (e.g., memory 108).

At block 602, the memory controller (e.g., memory controller 106) may execute a batch of write type sequences in a set of memory banks. The batch of write type sequences includes at least one write vector associated with a PIM transaction and at least one write command associated with a non-PIM transaction. For example, as previously discussed, executing a write vector (e.g., of the PIM transaction) may include inputting the write vector into the vector register 206 of a PIM memory bank 110. In some embodiments, executing a write command (e.g., of the non-PIM transaction) may include determining a corresponding write vector to input into the vector register 206.

In some embodiments, executing the batch of write type sequences includes executing the at least one write vector of the PIM transaction on a first PIM memory bank of the set of memory banks, and executing the at least one write command of the non-PIM transaction on remaining memory banks of the set of memory banks. For example, the first PIM memory bank may be an open or active memory bank that is usable and available for the PIM transaction, and which may be assigned for the PIM transaction. One or more of the remaining PIM memory banks may be idle or otherwise inactive. For example, the said remaining PIM memory banks may need to be activated, for example by unblocking or enabling a precharge function and an activation function to allow such memory banks to be repurposed or reused for the execution of the write commands of the non-PIM transaction.

At block 604, the memory controller (e.g., memory controller 106), after executing at least the write vector associated with the PIM transaction in the batch of write type sequences of block 602, may execute a batch of read type sequences. The batch of read type sequences may include at least one load MAC operation associated with the PIM transaction and at least one read command associated with the non-PIM transaction. For example, as previously discussed, executing a load MAC operation (e.g., of the PIM transaction) may include using the MAC unit 204 of the PIM memory bank 110 to perform the load MAC operation. In some embodiments, executing a read command (e.g., of the non-PIM transaction) may include determining a corresponding load MAC operation to perform using the MAC unit 204 of the PIM memory bank 110.

The memory controller may be prompted to execute the batch of read type sequences in block 602 based on one or more criteria described herein. For example, the memory controller may determine, after execution of the at least one write vector of the PIM transaction on the first PIM memory bank (as part of the execution of the batch of write-type sequences in block 602), that the at least one write command of the non-PIM transaction on the remaining memory banks is buffering. As previously discussed, the memory controller may determine that a transaction is buffering based on determining that the transaction is at an end of a page hit stream, determining that a page hit ratio of the transaction satisfies a predetermined threshold, and/or determining that a command queue occupancy rate of the transaction satisfies a predetermined threshold. If the at least one write command of the non-PIM transaction is buffering, the memory controller may suspend the execution of the at least one write command of the non-PIM transaction. The memory controller may thus execute the batch of read type sequences in the set of PIM memory banks in response to suspending the execution of the at least one write command of the non-PIM transaction. Also or alternatively, the memory controller may be prompted to execute the batch of read-type sequences in block 602 based on at least the competition of the execution of the write vectors associated with the PIM transaction in the batch of write-type sequences of block 602.

In some embodiments, executing the batch of read type sequences includes executing the at least one load MAC operation of the PIM transaction on an active PIM memory bank of the set of memory banks, and executing the at least one read command of the non-PIM transaction on remaining memory banks of the set of memory banks. For example, the active PIM memory bank may be an open memory bank that is usable and available for the PIM transaction, and which may be assigned for the PIM transaction. One or more of the remaining PIM memory banks may be idle or otherwise inactive. For example, the said remaining PIM memory banks may need to be activated, for example by unblocking or enabling a precharge function and an activation function to allow such memory banks to be repurposed or reused for the execution of the read commands of the non-PIM transaction.

In some embodiments, the memory controller may determine, during execution of the at least one write vector of the PIM transaction on the first PIM memory bank, that a latency of the non-PIM transaction (e.g., the execution of at least one write command of the non-PIM transaction on at least one of the remaining PIM memory banks) exceeds a QOS limit. As previously discussed, the memory controller may determine whether a latency of the non-PIM transaction exceeds a QOS limit by continuously, periodically, or semi-periodically monitoring a duration expended by the execution of the non-PIM transaction (e.g., execution of the at least one write commands of the non-PIM transaction) to see whether it exceeds a predefined time limit. A duration exceeding the QOS limit (e.g., the predefined time limit) may be deemed or understood to negatively impact a QOS for a user intended to use an application affected by the delay of the non-PIM application.

If the latency of the non-PIM transaction exceeds a QOS limit, the memory controller may swap the PIM memory bank used by the PIM transaction with the PIM memory bank used by the latent non-PIM transaction. For example, the memory controller may suspend the execution of the at least one write vector (of the PIM transaction) on the first PIM memory bank, and then execute at least a part of the non-PIM transaction on the first PIM memory bank (e.g., by unblocking an activation function and a precharge function for the non-PIM transaction on the first PIM memory bank). The at least one write vector of the PIM transaction may be resumed on at least one of the remaining PIM memory banks (e.g., by unblocking an activation function and a precharge function for the PIM transaction on the at least one of the remaining PIM memory banks). The at least one of the remaining PIM memory banks on which the PIM transaction is resumed may be the PIM memory bank previously used by the latent non-PIM transaction. By swapping and/or reassigning memory banks, the QOS of the non-PIM transaction can be optimized by having a more active memory bank service the non-PIM transaction in order to reduce or overcome the latency.

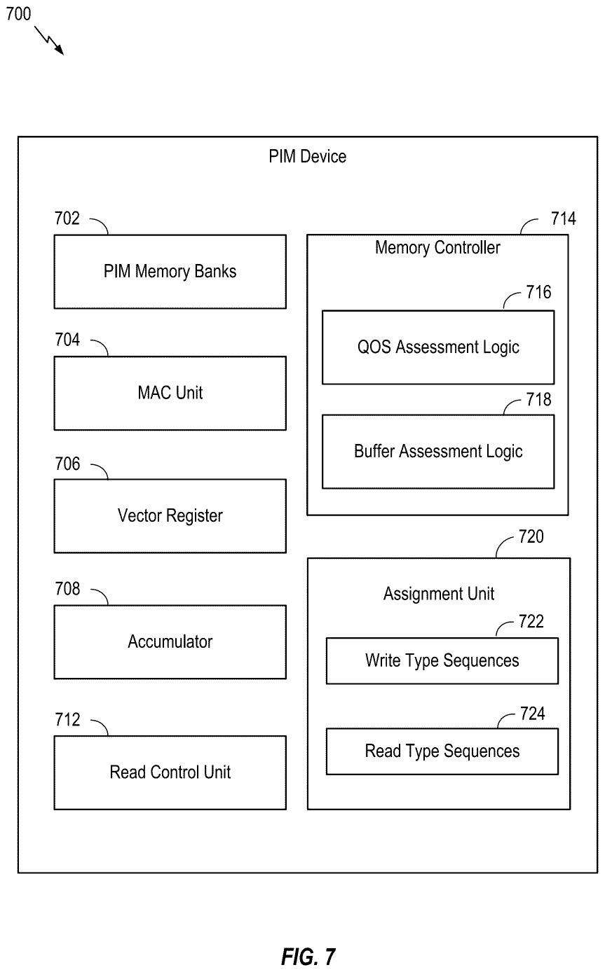

FIG. 7 illustrates a block diagram of a processing-in-memory (PIM) device 700 configured to shows a block diagram of an example PIM device configured to support processes 300-600 for the efficient and/or concurrent scheduling of PIM and non-PIM transactions according to one or more aspects of this disclosure. For example, the PIM device 700 may be configured to support the efficient scheduling of PIM and non-PIM transactions, as described by processes 300, 400A, and 400B, as well as support processes for scheduling PIM and non-PIM transactions concurrently based on read-type and write-type sequences, as described by processed 500 and 600.

PIM device 700 includes one or more DRAM banks 702 (such as, for example, DRAM bank 702) configured to store weight matrices and input vectors. Each DRAM bank 702 couples to a MAC unit 704 (such as, for example, MAC unit 704) through a data bus that enables transfer of matrix portions and vector data. MAC unit 704 performs matrix-vector multiplication operations on data retrieved from DRAM bank 702.

PIM device 700 includes one or more vector registers 706 (such as, for example, vector register 706) configured to store input vectors (e.g., write vectors) during processing or execution of transactions. One or more accumulator registers 717 (such as, for example, accumulator register 208) couples to MAC unit 704 through a dedicated path and accumulates results from matrix-vector operations. When implemented to support different bit-widths, MAC unit 74 includes circuitry configured to process weight values of a first bit-width (e.g., 4 bits) and input vector values of a second bit-width (e.g., 8 bits).

The memory controller 714 (such as, for example, memory controller 106) coordinates operations across device 700 through a control bus. The memory controller 714 may include a QOS assessment logic 716 that can determine whether a transaction complies or fails to comply with a QOS expected of an application pertaining to the transaction. For example, the memory controller 714 may determine or receive a QOS limit for an application or transaction, monitor the time expended by the processing or execution of a transaction or a sequence (e.g., read-type or write-type sequence) of the transaction to determine whether a latency associated with the transaction or sequence exceeds the QOS limit. The memory controller 714 may further include a buffer assessment logic 718 that can determine whether a transaction (e.g., a PIM transaction or a non-PIM transaction) is buffering. For example, the buffer assessment logic 718 may determine whether an execution of a transaction or sequence of the transaction is at an end of a page hit stream, whether a page hit ratio of the transaction satisfies a predetermined threshold, and/or whether a command queue occupancy rate of the transaction satisfies a predetermined threshold. In some embodiments, the buffer assessment logic may be able to identify whether page registers of the PIM memory banks 702 are active (e.g., open), idle, or inactive in order for the aforementioned determinations.

In some embodiments, for example, as shown in FIG. 7, the memory controller 714 may be a part of the PIM device 700. In other embodiments, the memory controller 714 may be located within the SoC clients and may interface with the PIM device 700 to schedule and orchestrate the switches between the PIM and non-PIM transactions as described herein.

In some embodiments, the PIM device 700 may further include an assignment unit 720 that can determine the write type sequences 722 and the read type sequences 724 of a transaction to assist the memory controller 714 in assigning memory banks for executing such sequences. For example, the assignment unit 720 may determine, from a PIM transaction, the write vectors as the write-type sequences and load MAC operations as the read-type sequences. Furthermore, the assignment unit 720 may determine, from a non-PIM transaction, the write commands as write-type sequences and read commands as the read type sequences. In some embodiments, the assignment unit 720 may determine, for the write commands of a non-PIM transaction, corresponding write vectors to input into the vector registers 706 for the execution of the non-PIM transaction. Furthermore, the assignment unit 720 may determine, for the read commands of a non-PIM transaction, corresponding load MAC operations to use on the MAC units 704 for the execution of the non-PIM transaction.

In operation, PIM device 700 performs processes 300 or 400A-B by having the memory controller 714 initiate execution of a first transaction that is one of a PIM transaction or a non-PIM transaction. For example, MAC unit 704 performs matrix-vector operations with results accumulating in accumulator 717 for commands associated with the first transaction. The memory controller 714 may prompt a switch to the second transaction that is the other of the PIM transaction or the non-PIM transaction. The switch may be prompted based on the failure to satisfy a QOS, as determined by the QOS assessment logic 716, or may be prompted based on a failure to satisfy an efficiency in the use of the PIM memory banks 702, as determined by the buffer assessment logic 718. Also or alternatively, PIM device 700 performs processes 500 or 600 by having the memory controller 714 initiate execution of one of write-type sequences 722 (of both PIM and non-PIM transactions) or read-type sequences 724 (of both PIM and non-PIM transactions). For example, the vector register 702 may input write vectors corresponding to the write-type sequences. Furthermore, the MAC unit 704 performs matrix-vector operations with results accumulating in accumulator 717 for the read-type sequences. The memory controller 714 may prompt a switch to the other of the write-type sequences or the read-type sequences based on the failure to satisfy a QOS, as determined by the QOS assessment logic 716, or the failure to satisfy an efficiency in the use of the PIM memory banks 702, as determined by the buffer assessment logic 718, or the completion of a write vector or load MAC operations of the PIM transaction.

It should be appreciated that device 700 includes means for performing steps to execute processes 300 through 600. In one or more aspects, techniques for efficiently and/or concurrently scheduling PIM and non-PIM transactions in the PIM device may include additional aspects, such as any single aspect or any combination of aspects described below or in connection with one or more other processes described elsewhere herein. Additionally, an apparatus may perform or operate according to one or more aspects as described below. In some implementations, the apparatus includes a processing-in-memory device. In some implementations, the apparatus includes at least one processor and a memory coupled to the processor. The processor may be configured to perform operations described herein with respect to the apparatus. In some other implementations, the apparatus may include a non-transitory computer-readable medium having program code recorded thereon, the program code being executable by a computer for causing the computer to perform operations described herein. In some implementations, the apparatus may include one or more means configured to perform operations described herein.

In a first aspect, a method of for efficiently scheduling processing-in-memory (PIM) and non-PIM transactions in a PIM device includes: initiating, by a memory controller of the PIM device, execution of a PIM transaction on a set of PIM memory banks of the PIM device; determining, by the memory controller, whether a latency of the PIM transaction exceeds a quality of service (QOS) limit; determining, by the memory controller, whether the PIM transaction is buffering if the latency of the PIM transaction does not exceed the QOS limit; suspending, by the memory controller, the execution of the PIM transaction based on the latency of the PIM transaction exceeding the QOS limit or based on the PIM transaction buffering if the latency of the PIM transaction does not exceed the QOS limit; and initiating, by the memory controller, execution of a non-PIM transaction on the set of PIM memory banks of the PIM device.

In a second aspect, in combination with the first aspect, suspending the execution of the PIM transaction includes blocking an activation function and a precharge function for the PIM transaction on the set of PIM memory banks of the PIM device, and initiating the non-PIM transaction includes unblocking an activation function and a precharge function for the non-PIM transaction on the set of PIM memory banks of the PIM device.

In a third aspect, in combination with one or more of the first aspect through the second aspect, determining whether the PIM transaction is buffering includes one or more of: determining, by the memory controller, whether the PIM transaction is at an end of a page hit stream; determining whether a page hit ratio of the PIM transaction satisfies a predetermined threshold; or determining whether a command queue occupancy rate of the PIM transaction satisfies a predetermined threshold.

In a fourth aspect, in combination with one or more of the first aspect through the third aspect, the method further includes: determining, by the memory controller, that a latency of the non-PIM transaction exceeds the QOS limit; suspending the execution of the non-PIM transaction based on the latency of the non-PIM transaction exceeding the QOS limit; and resuming, by the memory controller, execution of the PIM transaction.

In a fifth aspect, in combination with one or more of the first aspect through the fourth aspect, suspending the execution of the non-PIM transaction includes blocking an activation function and a precharge function for the non-PIM transaction on the set of PIM memory banks, and resuming execution of the PIM transaction includes unblocking an activation function and a precharge function for the PIM transaction on the set of PIM memory banks.

In a sixth aspect, in combination with one or more of the first aspect through the fifth aspect, the method further includes: determining, by the memory controller, that the PIM transaction has buffered above a buffer threshold if a latency of the non-PIM transaction does not exceed the QOS limit; suspending the execution of the non-PIM transaction based on the PIM transaction having buffered above the buffer threshold; and resuming, by the memory controller, execution of the PIM transaction.

In a seventh aspect, in combination with one or more of the first aspect through the sixth aspect, the method further includes: determining, by the memory controller, that the non-PIM transaction is buffering if a latency of the non-PIM transaction does not exceed the QOS limit; suspending the non-PIM transaction based on the non-PIM transaction buffering; and resuming, by the memory controller, execution of the PIM transaction.

In an eighth aspect, in combination with one or more of the first aspect through the seventh aspect, determining that the non-PIM transaction is buffering includes one or more of: determining that the non-PIM transaction is at an end of a page hit stream; determining that a page hit ratio of the non-PIM transaction fails to satisfy a predetermined threshold; or determining that a command queue occupancy rate of the non-PIM transaction fails to satisfy a predetermined threshold.

In a ninth aspect, a method for efficiently scheduling processing-in-memory (PIM) and non-PIM transactions in a memory device is disclosed. The method includes: executing, by a memory controller, a batch of write type sequences in a set of PIM memory banks, wherein the batch of write type sequences includes at least one write vector associated with a PIM transaction and at least one write command associated with a non-PIM transaction; and executing, by the memory controller, after execution of the at least one write vector associated with the PIM transaction, a batch of read type sequences in the set of PIM memory banks, wherein the batch of read type sequences includes at least one load MAC operation associated with the PIM transaction and at least one read command associated with the non-PIM transaction.

In a tenth aspect, in combination with the ninth aspect, executing the batch of write type sequences includes: executing the at least one write vector of the PIM transaction on a first PIM memory bank of the set of memory banks; and executing the at least one write command of the non-PIM transaction on remaining memory banks of the set of memory banks.

In an eleventh aspect, in combination with the ninth aspect through the tenth aspect, the method further includes: determining, by the memory controller, during execution of the at least one write vector of the PIM transaction on the first PIM memory bank, that a latency of the non-PIM transaction exceeds a QOS limit; suspending execution of the at least one write vector on the first PIM memory bank based on the latency of the non-PIM transaction; executing, by the memory controller, at least a part of the non-PIM transaction on the first PIM memory bank; and resuming, by the memory controller, execution of the at least one write vector of the PIM transaction on at least one of the remaining PIM memory banks of the set of PIM memory banks.

In a twelfth aspect, in combination with one or more of the ninth aspect through the eleventh aspect, executing at least the part of the non-PIM transaction on the first memory bank includes unblocking an activation function and a precharge function for the non-PIM transaction on the first PIM memory bank; and resuming execution of the at least one write vector of the PIM transaction on at least one of the remaining PIM memory banks includes unblocking an activation function and a precharge function for the PIM transaction on the at least one of the remaining PIM memory banks.

In a thirteenth aspect, in combination with one or more of the ninth aspect through the twelfth aspect, the method further includes: determining, by the memory controller, after execution of the at least one write vector of the PIM transaction on the first PIM memory bank, that the at least one write command of the non-PIM transaction on the remaining memory banks is buffering; and suspending execution of the at least one write command of the non-PIM transaction based on the at least one write command buffering, wherein executing the batch of read type sequences in the set of PIM memory banks is responsive to suspending the execution of the at least one write command of the non-PIM transaction.

In a fourteenth aspect, in combination with one or more of the ninth aspect through the thirteenth aspect, determining that the at least one write command of the non-PIM transaction is buffering includes one or more of: determining that the at least one write command is at an end of a page hit stream; determining that a page hit ratio of the at least one write command fails to satisfy a predetermined threshold; or determining that a command queue occupancy rate of the at least one write command fails to satisfy a predetermined threshold.

In a fifteenth aspect, in combination with one or more of the ninth aspect through the fourteenth aspect, executing the batch of read type sequences includes: executing the at least one load MAC operation of the PIM transaction on a first PIM memory bank of the set of PIM memory banks; and executing the at least one read command of the non-PIM transaction on remaining memory banks of the set of PIM memory banks.

In a sixteenth aspect, a processing-in-memory (PIM) device for efficiently scheduling PIM and non-PIM transaction is disclosed. The PIM device includes: a memory comprising a set of PIM memory banks; and a memory controller coupled to the memory, and configured to perform operations including: initiating execution of a PIM transaction on the set of PIM memory banks; determining whether a latency of the PIM transaction exceeds a quality of service (QOS) limit; determining whether the PIM transaction is buffering if the latency of the PIM transaction does not exceed the QOS limit; suspending the execution of the PIM transaction based on the latency of the PIM transaction exceeding the QOS limit or based on the PIM transaction buffering if the latency of the PIM transaction does not exceed the QOS limit; and initiating execution of a non-PIM transaction on the set of PIM memory banks of the PIM device.

In a seventeenth aspect, in combination with the sixteenth aspect, the memory controller is configured to suspend the execution of the PIM transaction by blocking an activation function and a precharge function for the PIM transaction on the set of PIM memory banks, wherein the memory controller is configured to initiate the execution of the non-PIM transaction by unblocking an activation function and a precharge function for the non-PIM transaction on the set of PIM memory banks.

In an eighteenth aspect, in combination with one or more of the sixteenth aspect through the seventeenth aspect, the memory controller is configured to determine whether the PIM transaction is buffering by: determining whether the PIM transaction is at an end of a page hit stream; determining whether a page hit ratio of the PIM transaction satisfies a predetermined threshold; or determining whether a command queue occupancy rate of the PIM transaction satisfies a predetermined threshold.

In a nineteenth aspect, in combination with one or more of the sixteenth aspect through the eighteenth aspect, the memory controller is configured to perform operations further including: determining that a latency of the non-PIM transaction exceeds the QOS limit; suspending the execution of the non-PIM transaction based on the latency of the non-PIM transaction exceeding the QOS limit; and resuming, by the memory controller, execution of the PIM transaction.

In a twentieth aspect, in combination with one or more of the sixteenth through the nineteenth aspect, the memory controller is configured to perform operations further including: determining that the PIM transaction has buffered above a buffer threshold; suspending the execution of the non-PIM transaction based on the PIM transaction having buffered above the buffer threshold; and resuming execution of the PIM transaction.

In a twenty first aspect, a processing-in-memory (PIM) device for efficiently scheduling PIM and non-PIM transaction is disclosed. The PIM device includes: a memory comprising a set of PIM memory banks; and a memory controller coupled to the memory, and configured to perform operations including: executing a batch of write type sequences in a set of PIM memory banks, wherein the batch of write type sequences includes at least one write vector associated with a PIM transaction and at least one write command associated with a non-PIM transaction; and executing, after execution of the at least one write vector associated with the PIM transaction, a batch of read type sequences in the set of PIM memory banks, wherein the batch of read type sequences includes at least one load MAC operation associated with the PIM transaction and at least one read command associated with the non-PIM transaction.

In a twenty second aspect, in combination with the twenty first aspect, the memory controller is configured to execute the batch of write type sequences by: executing the at least one write vector of the PIM transaction on a first PIM memory bank of the set of memory banks; and executing the at least one write command of the non-PIM transaction on remaining memory banks of the set of memory banks.

In a twenty third aspect, in combination with one or more of the twenty first aspect through the twenty second aspect, the memory controller is configured to perform operations further including: determining, during execution of the at least one write vector of the PIM transaction on the first PIM memory bank, that a latency of the non-PIM transaction exceeds a QOS limit; suspending execution of the at least one write vector on the first PIM memory bank based on the latency of the non-PIM transaction; executing at least a part of the non-PIM transaction on the first PIM memory bank; and resuming execution of the at least one write vector of the PIM transaction on at least one of the remaining PIM memory banks of the set of PIM memory banks.

In a twenty fourth aspect, in combination with one or more of the twenty first aspect through the twenty third aspect, the memory controller is configured to execute at least the part of the non-PIM transaction on the first memory bank by unblocking an activation function and a precharge function for the non-PIM transaction on the first PIM memory bank; and the memory controller is configured to resume execution of the at least one write vector of the PIM transaction on at least one of the remaining PIM memory banks by unblocking an activation function and a precharge function for the PIM transaction on the at least one of the remaining PIM memory banks.

In a twenty fifth aspect, in combination with one or more of the twenty first aspect through the twenty fourth aspect, the memory controller is configured to perform operations further including: determining, after execution of the at least one write vector of the PIM transaction on the first PIM memory bank, that the at least one write command of the non-PIM transaction on the remaining memory banks is buffering; and suspending execution of the at least one write command of the non-PIM transaction based on the at least one write command buffering, wherein executing the batch of read type sequences in the set of PIM memory banks is responsive to suspending the execution of the at least one write command of the non-PIM transaction.

In a twenty sixth aspect, in combination with one or more of the twenty first aspect through the twenty fifth aspect, the memory controller is configured to determine that the at least one write command of the non-PIM transaction is buffering by one or more of: determining that the at least one write command is at an end of a page hit stream; determining that a page hit ratio of the at least one write command fails to satisfy a predetermined threshold; or determining that a command queue occupancy rate of the at least one write command fails to satisfy a predetermined threshold.

In a twenty seventh aspect, in combination with one or more of the twenty first aspect through the twenty sixth aspect, the memory controller is configured to execute the batch of read type sequences by: executing the at least one load MAC operation of the PIM transaction on a first PIM memory bank of the set of PIM memory banks; and executing the at least one read command of the non-PIM transaction on remaining memory banks of the set of PIM memory banks.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it should be appreciated that throughout this disclosure, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as, e.g., “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for efficiently scheduling processing-in-memory (PIM) and non-PIM transactions in a PIM device, the method comprising:
initiating, by a memory controller of the PIM device, execution of a PIM transaction on a set of PIM memory banks of the PIM device;
determining, by the memory controller, whether a latency of the PIM transaction exceeds a quality of service (QOS) limit;
determining, by the memory controller, whether the PIM transaction is buffering if the latency of the PIM transaction does not exceed the QOS limit;
suspending, by the memory controller, the execution of the PIM transaction based on the latency of the PIM transaction exceeding the QOS limit or based on the PIM transaction buffering if the latency of the PIM transaction does not exceed the QOS limit; and
initiating, by the memory controller, execution of a non-PIM transaction on the set of PIM memory banks of the PIM device.

2. The method of claim 1,
wherein suspending the execution of the PIM transaction comprises blocking an activation function and a precharge function for the PIM transaction on the set of PIM memory banks of the PIM device,
wherein initiating the execution of the non-PIM transaction comprises unblocking an activation function and a precharge function for the non-PIM transaction on the set of PIM memory banks of the PIM device.

3. The method of claim 1, wherein determining whether the PIM transaction is buffering comprises one or more of:
determining, by the memory controller, whether the PIM transaction is at an end of a page hit stream;
determining whether a page hit ratio of the PIM transaction satisfies a predetermined threshold; or
determining whether a command queue occupancy rate of the PIM transaction satisfies a predetermined threshold.

4. The method of claim 1, further comprising:
determining, by the memory controller, that a latency of the non-PIM transaction exceeds the QOS limit;
suspending the execution of the non-PIM transaction based on the latency of the non-PIM transaction exceeding the QOS limit; and
resuming, by the memory controller, execution of the PIM transaction.

5. The method of claim 4,
wherein suspending the execution of the non-PIM transaction comprises blocking an activation function and a precharge function for the non-PIM transaction on the set of PIM memory banks,
wherein resuming execution of the PIM transaction comprises unblocking an activation function and a precharge function for the PIM transaction on the set of PIM memory banks.

6. The method of claim 1, further comprising:
determining, by the memory controller, that the PIM transaction has buffered above a buffer threshold if a latency of the non-PIM transaction does not exceed the QOS limit;
suspending the execution of the non-PIM transaction based on the PIM transaction having buffered above the buffer threshold; and
resuming, by the memory controller, execution of the PIM transaction.

7. The method of claim 1, further comprising:
determining, by the memory controller, that the non-PIM transaction is buffering if a latency of the non-PIM transaction does not exceed the QOS limit;
suspending the non-PIM transaction based on the non-PIM transaction buffering; and
resuming, by the memory controller, execution of the PIM transaction.

8. The method of claim 7, wherein determining that the non-PIM transaction is buffering comprises one or more of:
determining that the non-PIM transaction is at an end of a page hit stream;
determining that a page hit ratio of the non-PIM transaction fails to satisfy a predetermined threshold; or
determining that a command queue occupancy rate of the non-PIM transaction fails to satisfy a predetermined threshold.

9. A method for efficiently scheduling processing-in-memory (PIM) and non-PIM transactions in a memory device, the method comprising:
executing, by a memory controller, a batch of write type sequences in a set of PIM memory banks, wherein the batch of write type sequences comprises at least one write vector associated with a PIM transaction and at least one write command associated with a non-PIM transaction; and
executing, by the memory controller, after execution of the at least one write vector associated with the PIM transaction, a batch of read type sequences in the set of PIM memory banks, wherein the batch of read type sequences comprises at least one load MAC operation associated with the PIM transaction and at least one read command associated with the non-PIM transaction.

10. The method of claim 9, wherein executing the batch of write type sequences comprises:
executing the at least one write vector of the PIM transaction on a first PIM memory bank of the set of memory banks; and
executing the at least one write command of the non-PIM transaction on remaining memory banks of the set of memory banks.

11. The method of claim 10, further comprising:
determining, by the memory controller, during execution of the at least one write vector of the PIM transaction on the first PIM memory bank, that a latency of the non-PIM transaction exceeds a QOS limit;
suspending execution of the at least one write vector on the first PIM memory bank based on the latency of the non-PIM transaction;
executing, by the memory controller, at least a part of the non-PIM transaction on the first PIM memory bank; and
resuming, by the memory controller, execution of the at least one write vector of the PIM transaction on at least one of the remaining PIM memory banks of the set of PIM memory banks.

12. The method of claim 11,
wherein executing at least the part of the non-PIM transaction on the first PIM memory bank comprises unblocking an activation function and a precharge function for the non-PIM transaction on the first PIM memory bank,
wherein resuming execution of the at least one write vector of the PIM transaction on at least one of the remaining PIM memory banks comprises unblocking an activation function and a precharge function for the PIM transaction on the at least one of the remaining PIM memory banks.

13. The method of claim 10, further comprising:
determining, by the memory controller, after execution of the at least one write vector of the PIM transaction on the first PIM memory bank, that the at least one write command of the non-PIM transaction on the remaining memory banks is buffering; and
suspending execution of the at least one write command of the non-PIM transaction based on the at least one write command buffering, wherein executing the batch of read type sequences in the set of PIM memory banks is responsive to suspending the execution of the at least one write command of the non-PIM transaction.

14. The method of claim 13, wherein the determining that the at least one write command of the non-PIM transaction is buffering comprises one or more of:
determining that the at least one write command is at an end of a page hit stream;
determining that a page hit ratio of the at least one write command fails to satisfy a predetermined threshold; or
determining that a command queue occupancy rate of the at least one write command fails to satisfy a predetermined threshold.

15. The method of claim 9, wherein executing the batch of read type sequences comprises:
executing the at least one load MAC operation of the PIM transaction on a first PIM memory bank of the set of PIM memory banks; and
executing the at least one read command of the non-PIM transaction on remaining memory banks of the set of PIM memory banks.

16. A processing-in-memory (PIM) device for efficiently scheduling PIM and non-PIM transactions, the PIM device comprising:
a memory comprising a set of PIM memory banks; and
a memory controller coupled to the memory, and configured to perform operations comprising:
initiating execution of a PIM transaction on the set of PIM memory banks;
determining whether a latency of the PIM transaction exceeds a quality of service (QOS) limit;
determining whether the PIM transaction is buffering if the latency of the PIM transaction does not exceed the QOS limit;
suspending the execution of the PIM transaction based on the latency of the PIM transaction exceeding the QOS limit or based on the PIM transaction buffering if the latency of the PIM transaction does not exceed the QOS limit; and
initiating execution of a non-PIM transaction on the set of PIM memory banks of the PIM device.

17. The PIM device of claim 16,
wherein the memory controller is configured to suspend the execution of the PIM transaction by blocking an activation function and a precharge function for the PIM transaction on the set of PIM memory banks,
wherein the memory controller is configured to initiate the execution of the non-PIM transaction by unblocking an activation function and a precharge function for the non-PIM transaction on the set of PIM memory banks.

18. The PIM device of claim 16, wherein the memory controller is configured to determine whether the PIM transaction is buffering by:
determining whether the PIM transaction is at an end of a page hit stream;
determining whether a page hit ratio of the PIM transaction satisfies a predetermined threshold; or
determining whether a command queue occupancy rate of the PIM transaction satisfies a predetermined threshold.

19. The PIM device of claim 16, wherein the memory controller is configured to perform operations further comprising:
determining that a latency of the non-PIM transaction exceeds the QOS limit;
suspending the execution of the non-PIM transaction based on the latency of the non-PIM transaction exceeding the QOS limit; and
resuming, by the memory controller, execution of the PIM transaction.

20. The PIM device of claim 16, wherein the memory controller is configured to perform operations further comprising:
determining that the PIM transaction has buffered above a buffer threshold;
suspending the execution of the non-PIM transaction based on the PIM transaction having buffered above the buffer threshold; and
resuming execution of the PIM transaction.
